(19) United States
(12) Patent Application Publication
(10) Pub. No.: US 2009/0282220 A1
(43) Pub. Date: Nov. 12, 2009

(54) Microprocessor with Compact Instruction Set Architecture

(75) Inventor: Erik K. Norden, Munchen (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: MIPS Technologies, Inc., Sunnyvale, CA (US)

(21) Appl. No.: 12/463,330

(22) Filed: May 8, 2009

Related U.S. Application Data
(60) Provisional application No. 61/051,642, filed on May 8, 2008.

(51) Int. Cl. G06F 9/30

(52) U.S. Cl. 712/205; 712/41; 712/208; 712/E09.016

(57) ABSTRACT

A re-encoded instruction set architecture (ISA) provides smaller bit-width instructions or a combination of smaller and larger bit-width instructions to improve instruction execution efficiency and reduce code footprint. The ISA can be re-encoded from a legacy ISA having larger bit-width instructions and can be used to unify one or more ISA extensions such as application specific ASEs. The re-encoded ISA maintains assembly-level compatibility with the ISA from which it is derived. In addition, the re-encoded ISA can have new and different types of additional instructions.

### CROSS REFERENCE TO RELATED APPLICATIONS

This patent application claims the benefit of U.S. Provisional Patent Application No. 61/051,642 filed on May 8, 2008, entitled “Compact Instruction Set Architecture,” which is incorporated by reference herein in its entirety.

### FIELD OF THE INVENTION

Embodiments of the present invention relate generally to microprocessors. More particularly, embodiments of the present invention relate to instruction set architectures for microprocessors.

### BACKGROUND OF THE INVENTION

There is an expanding need for economical, high performance microprocessors, especially for deeply embedded applications such as microcontroller applications. As a result, microprocessor customers require efficient solutions that can be quickly and effectively integrated into products. Moreover, designers and microprocessor customers continue to demand lower power consumption, and have recently focused on environmentally friendly microprocessor-powered devices.

One way to achieve these requirements is to revise an existing instruction set (also known herein as an Instruction Set Architecture (ISA)) into a new instruction set having a smaller code footprint. The smaller code footprint generally translates into lower power consumption per executed task. Smaller instruction sizes may also lead to higher performance. One reason for this improved efficiency is the lower number of memory accesses required to fetch the smaller instruction. Additional benefits may be derived by basing a new ISA on a combination of smaller bit-width and larger bit-width instructions derived from an ISA having a larger bit-width.

### SUMMARY OF THE INVENTION

Embodiments of the present invention relate to re-encoding instruction set architectures to be used with a microprocessor, and new instructions resulting therefrom. According to an embodiment, a larger bit-width instruction set is re-encoded to a smaller bit-width instruction set or an instruction set having a combination of smaller bit-width instructions and larger bit-width instructions. In embodiments, the smaller bit-width instruction set retains assembly-level compatibility with the larger bit-width instruction set from which it is derived and has different types of instructions added. Moreover, the new smaller bit-width instruction set or combined smaller and larger bit-width instruction sets may be more efficient and have higher performance than the larger bit-width instruction set from which it was re-encoded.

In an embodiment, several new smaller bit-width instructions are added to the new instruction set, including: Compact Branch on Equal to Zero (BEQZC), Compact Branch on not Equal to Zero (BNEZC), Jump and Link Exchange (JALX), Compact Jump Register (JRC), Load Register Pair (LRP), Load Word Multiple (LWM), Store Register Pair (SRP) and StoreWord Multiple (SWM).

### BRIEF DESCRIPTION OF THE FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 is a schematic diagram of a format of a 32-bit instruction for and ISA according to an embodiment of the present invention.

FIG. 2 is a schematic diagram of a format of a 16-bit instruction for an ISA according to an embodiment of the present invention.

FIG. 3A is a schematic diagram illustrating the format for a Compact Branch on Equal to Zero (BEQZC) instruction according to an embodiment of the present invention.

FIG. 3B is a flowchart illustrating operation of a BEQZC instruction in a microprocessor according to an embodiment of the present invention.

FIG. 3C is a schematic diagram illustrating the format for a Compact Branch on Not Equal to Zero (BNEZC) instruction according to an embodiment of the present invention.

FIG. 3D is a flowchart illustrating operation of a BNEZC instruction in a microprocessor according to an embodiment of the present invention.

FIG. 3E is a schematic diagram showing the format for a Jump and Link Exchange (JALX) instruction according to an embodiment of the present invention.

FIG. 3F is a flowchart illustrating operation of a JALX instruction in a microprocessor according to an embodiment.

FIG. 3G is a schematic diagram showing the format of a second embodiment of the JALX instruction.

FIG. 3H is a flowchart illustrating operation of the JALX instruction according to a second embodiment.

FIG. 3I is a schematic diagram showing the format for a Compact Jump Register (JRC) instruction according to an embodiment of the present invention.

FIG. 3J is a flowchart illustrating operation of a JRC instruction in a microprocessor according to an embodiment.

FIG. 3K is schematic diagram showing the format for a Load Register Pair (LRP) instruction according to an embodiment of the present invention.

FIG. 3L is a flowchart illustrating operation of an LRP instruction according to an embodiment. In step 340, register (rt), register (base) and offset are obtained.

FIG. 3M is a schematic diagram showing the format for a Load Word Multiple (LWM) instruction according to an embodiment of the present invention.

FIG. 3N is a flowchart illustrating operation of the LWM instruction in a microprocessor according to an embodiment.

FIG. 3O is a schematic diagram showing the format for a Store Register Pair (SRP) instruction according to an embodiment of the present invention.

FIG. 3P is a flowchart illustrating operation of an SRP instruction according to an embodiment.

FIG. 3Q is a schematic diagram showing the format for a storeword multiple (SWM) instruction according to an embodiment of the present invention.

FIG. 3R is a flowchart illustrating operation of a SWM instruction according to an embodiment.

FIG. 4 is a schematic diagram of a microprocessor core according to an embodiment of the present invention.

### DETAILED DESCRIPTION OF EMBODIMENTS

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility. The following sections describe an instruction set architecture according to an embodiment of the present invention.

### I. Overview

### II. Re-encoded Architecture

a. Assembly Level Compatibility

b. Special Event ISA Mode Selection

### III. New Types of Instructions

a. Re-encoded Branch and Jump Instructions

b. Encoded Fields Based on Statistical Analysis

c. Delay Slots

### IV. Instruction Formats

a. Principle Opcode Organization

b. Major Opcodes

### V. Re-Encoded Instructions

a. New 16-Bit Instructions Re-Encoded from 32-Bit Instructions

b. New 32-Bit Instructions Re-Encoded from Legacy 32-Bit Instructions

c. 16-Bit User Defined Instructions (UDIs)

d. Unification of ASEs

e. New ISA Instructions

### VI. Example Processor Core

### VII. Conclusion

### I. Overview

Embodiments described herein relate to an ISA comprising instructions to be executed on a microprocessor and a microprocessor on which the instruction of the ISA can be executed. Some embodiments described herein relate to an ISA that resulted from re-encoding a larger bit-width ISA to a combined smaller and larger bit-width ISA. In one embodiment, the larger bit-width ISA is MIPS32 available from MIPS, INC. of Mountain View, Calif., the re-encoded smaller bit-width ISA is the MicroMIPS 16-bit instruction set also available from MIPS, INC., and the re-encoded larger bit-width ISA is the MicroMIPS 32-bit instruction set, also available from MIPS, INC.

In another embodiment, the larger bit-width architecture may be re-encoded into an improved architecture with the same bit-width or a combination of same bit-width instructions and smaller bit-width instructions. In one embodiment, the re-encoded larger-bit width instruction set is encoded to a same size bit-width ISA, in such a fashion as to be compatible with, and complementary to, a re-encoded smaller bit-width instruction set of the type discussed herein. Embodiments of the re-encoded larger bit width instruction set may be termed as “enhanced,” and may contain various features, discussed below, that allow the new instruction set to be implemented in a parallel mode, where both instruction sets may be utilized on a processor. Re-encoded instruction sets described herein also work in a standalone mode, where only one instruction set is active at a time.

### II. Re-Encoded Architecture

a. Assembly Level Compatibility

Embodiments described herein retain assembly-level compatibility after re-encoding from the larger bit-width to the smaller bit-width or combined bit width ISAs. To accomplish this, in one embodiment, post-re-encoding assembly language instruction set mnemonics are the same as the instructions from which they are derived. Maintaining assembly level compatibility allows instruction set assembly source code, using the larger bit-width ISA, to be compiled with assembly source code using the smaller bit-width ISA. In other words, an assembler targeting the new ISA embodiments of the present invention can also assemble legacy ISAs from which embodiments of the present invention were derived.

In an embodiment, the assembler determines which ISA to use to process a particular instruction. For example, to differentiate between instructions of different bit-width ISAs, in an embodiment, the opcode mnemonic is extended with a suffix corresponding to the different size. For example, in one embodiment, a “16” or “32” suffix is placed at the end of the instruction before the first “.”, if one exists, to distinguish between 16-bit and 32-bit encoded instructions. For example, in one embodiment, “ADD16” refers to a 16-bit version of an ADD instruction, and “ADD32” refers to a 32-bit version of the ADD instruction. As would be known to one skilled in the art, other suffices may be used.

Other embodiments do not use suffix designations of instruction size. In such embodiments, the bit-width suffices may be omitted. In an embodiment, the assembler will look at the values in a command's register and immediate fields and decide whether a larger or smaller bit-width command is appropriate. Depending upon assembler settings, the assembler may automatically choose the smallest available instruction size when processing a particular instruction.

b. Special Event ISA Mode Selection

In another embodiment, ISA selection occurs in one of the following circumstances: exceptions, interrupts and power-on events. In such an embodiment, a handler that is handling the special event specifies the ISA. For example, on power-on a power-on handler can specify the ISA. Likewise, an interrupt or exception handler can specify the ISA.

### III. New Types of Instructions

Embodiments having new ISA instructions are be described below, as well as embodiments with re-encoded instructions. Several general principles have been used to develop these instructions, and these are explained below.

a. Re-Encoded Branch and Jump Instructions

In one embodiment, the re-encoded smaller bit-width ISA supports smaller branch target addresses, providing enhanced flexibility. For example, in one embodiment, a 32-bit branch instruction re-encoded as a 16-bit branch instruction supports 16-bit-aligned branch target addresses.

In another example, because the offset field size of the 32-bit re-encoded branch instruction remains identical to the legacy 32-bit re-encoded instructions, the branch range may be smaller. In further embodiments, the jump instructions J, JAL and JALX support the entire jump range by supporting 32-bit aligned target addresses.

b. Encoded Fields Based on Statistical Analysis

The term ‘immediate field’ as used herein and is well known in the art. In embodiments, the immediate field can include the address offset field for branches, load/store instructions, and target fields. In embodiments, the immediate field width and position within the instruction encoding is instruction dependent. In an embodiment, the immediate field of an instruction is split into several fields that need not be adjacent.

In an embodiment, use of certain register and immediate values for ISA instructions and macros, may convey a higher level of performance than other values. Embodiments described herein use this principle to enhance the performance of instructions. For example, to achieve such performance, in one embodiment, analysis of the statistical frequency of values used in register and immediate fields over a period of usage of an ISA is performed. Based on this analysis, embodiments, instead of using unmodified register or immediate values, encode the values to link the highest performance register and immediate values to the most commonly used values, as determined by the statistical analysis above.

To assist in the re-encoding of an ISA as described herein, the above encoding approach also may allow a reduction in the required size of register and immediate fields, because certain less common values may be omitted from encoding. For example, encoded register and immediate values may be encoded into a shorter bit-width than the original value, e.g., “1001” may encode to “10.” When recoding larger bit-width instruction sets to smaller bit-width ISAs, less frequently used values may be omitted from the new list.

c. Delay Slots

In a pipelined architecture, a delay slot is filled by an instruction that is executed without the effects of a preceding instruction, for example a single instruction located immediately after a branch instruction. A delay slot instruction will execute even if the preceding branch is taken. Delay slots may increase efficiency, but are not efficient for all applications. For example, for certain applications (e.g., high performance applications), not using delay slots has little, if any impact on making the resulting code smaller. At times, a compiler attempting to fill a delay slot cannot find a useful instruction. In such cases, a no operation (NOP) instruction is placed in the delay slot, which may add to a program's footprint and decrease performance efficiency.

Embodiments described herein offer a developer a choice when using of delay slots. Given this choice, a developer may choose how best to use delay slots so as to maximize desired results, e.g., code size, performance efficiency, and ease of development. In an embodiment, certain instructions described herein have two versions—exemplary instructions are the jump of branch instructions. Such instructions have one version with a delay slot and one version without a delay slot. In an embodiment, which version to use is software selected when the instruction is coded. In another embodiment, which version to use is selected by the developer (as with the selection of ADD16 or ADD32 described above). In yet another embodiment, which version to use is selected automatically by the assembler (as described above). This feature in such embodiments may also help maintain compatibility with legacy hardware processors.

In another embodiment, the size of a delay slot is fixed. Embodiments herein involve an instruction set with two sizes of instructions (e.g., 16 bit and 32 bit). A fixed-width delay slot allows a designer to define a delay slot instruction so that the size will always be a certain size, e.g., a larger bit-width slot or shorter bit-width slot. This delay slot selection allows a designer to broadly pursue different development goals. To minimize code footprint, a uniformly smaller bit-width delay slot might be selected. However, this may result in a higher likelihood that the smaller slots might not be filled. In contrast, to maximize the potential performance benefit of the delay slot, a larger bit-width slot may be selected. This choice, however, may increase code footprint.

In an embodiment, delay slot width may be selected by the designer as either a larger bit-width or smaller bit-width at the time the instruction is coded. This is similar to the embodiments described herein that allow for manual selection of instruction bit-width (ADD16 or ADD32). As with the fixed bit-width selection described above, this delay slot selection allows a designer to pursue different development goals. With this approach however, the bit-width choice may be made for each command, as opposed to the system overall.

As would be appreciated by one skilled in the art, approaches to delay slots described above may be applied to any instruction that is capable of using delay slots.

### IV. Instruction Formats

In an embodiment the new ISA comprises instructions having at least two different bit widths. For example, an ISA according to an embodiment includes instructions that have 16-bit and 32-bit widths. Although embodiments of the new ISA described herein describe two instruction sets that operate in a complementary fashion, the teachings herein would apply to any number of ISA instruction sets.

In an embodiment, instructions have opcodes comprising a major, and in some cases a minor opcode. The major opcode has a fixed width, while the minor opcode has a width that depends on the instruction, including widths large enough to access an entire register set. For example, in one embodiment, the MOVE instruction has a 5-bit minor opcode, and may reach the entire register set. For example, in one embodiment, encoding comprises 16-bit and 32-bit wide instructions, both having a 6-bit major opcode right aligned within the instruction encoding, followed by a variable width minor opcode.

The major opcode is the same for both the larger bit-width and smaller bit-width instruction sets. For example, in one embodiment, encoding comprises 16-bit and 32-bit wide instructions, both having a 6-bit major opcode right aligned within the instruction encoding, followed by a variable width minor opcode.

a. Principle Opcode Organization

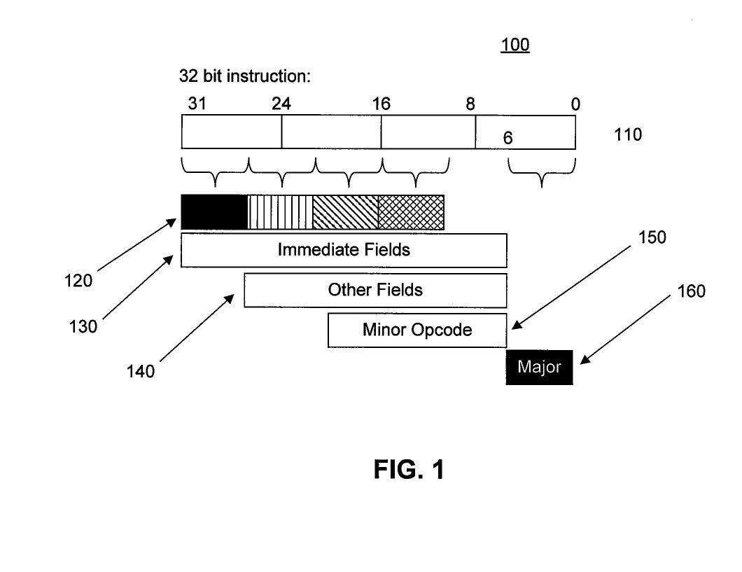

FIG. 1 is a schematic diagram of a format 110 for a 32-bit re-encoded instruction, according to an embodiment. Embodiments of instruction format 110 may have zero, one, or more left aligned register fields 120, followed by optional immediate fields 130. In one embodiment, 32-bit re-encoded instructions have 5-bit wide register fields 120. Other optional instruction specific fields 140 may be located between the immediate fields 130 and the opcode field. In an exemplary embodiment, instructions can have 0 to 4 left aligned register fields 120, followed by the optional immediate field 130. Other optional instruction specific fields 140 are located between immediate field 130 and opcode fields 150 or 160. As described above, the opcode field comprises a major opcode 160 and, in some cases, a minor opcode 150.

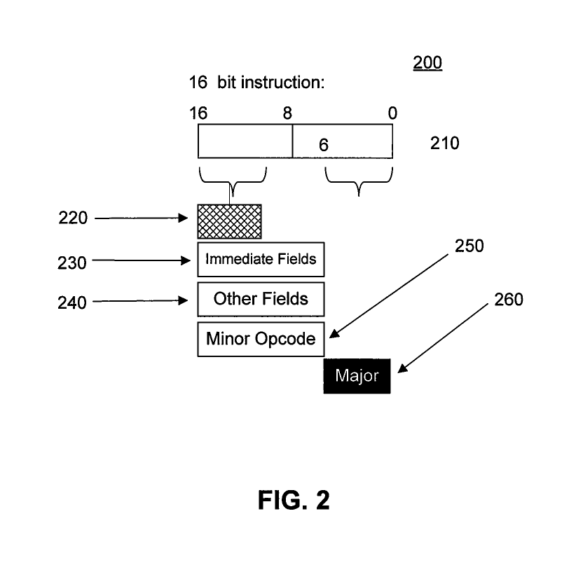

FIG. 2 is a schematic diagram of a format 210 for a 16-bit instruction 200, according to an embodiment. Embodiments of instruction format 210 may have zero, one, or more registers fields 220. In one embodiment, 16-bit instructions use 3-bit registers 220, and use instruction-specific register encoding. Instruction-specific register encoding relates to the mapping, for a particular instruction, of a particular portion of the register space to 3-bit registers in a 16-bit instruction.

In an embodiment, 16-bit instructions may use larger bit-widths registers 220, including widths large enough to access an entire register set. For example, in one embodiment, a 16-bit MOVE instruction has 5-bit register fields. Use of 5-bit register fields allows the 16-bit MOVE instructions to access any register in a register set having 32 registers. In an embodiment, 16-bit instructions can further include one or more immediate fields 230. Other optional instruction specific fields 240 may be to the left of the opcode 260 or 250. In an exemplary embodiment, 16-bit instructions can have 0 to 1 left aligned register fields 220. An opcode field comprises a major opcode 260 and, in some cases, a minor opcode field 250 appears to the right of any other fields 240.

b. Major Opcodes Table 1 provides a listing of instructions formats for an ISA according to an embodiment. As can be seen from Table 1, instructions in the exemplary ISA have 16 or 32 bits. Nomenclature for the instruction formats appearing in Table 1 are based on the number of register fields and immediate field size for the instruction format. That is, the instruction names have the format R<x>I<y>. Where <x> is the number of register in the instruction format and <y> is the immediate field size. For example, an instruction based on the format R2I16 has two register fields and a 16-bit immediate field.

TABLE 1
Instruction Set Formats

| | 32 bit | |
|---|---|---|
| 32 bit | Instruction Formats | |
| Instruction Formats | (additional format(s) | 16 bit |
| (existing instructions) | for new instructions) | Instruction Formats |
| R0I0 | R2I12 | S3R0I0 |
| R0I8 | | S3R0I10 |
| R0I16 | | S3R1I0 |
| R0I26 | | S3R1I7 |
| R1I0 | | S3R2I0 |
| R1I2 | | S3R2I3 |
| R1I7 | | S3R2I4 |
| R1I8 | | S3R3I0 |
| R1I10 | | S5R1I0 |
| R1I16 | | S5R2I0 |
| R2I0 | | |
| R2I2 | | |
| R2I3 | | |
| R2I4 | | |
| R2I5 | | |
| R2I10 | | |
| R2I16 | | |
| R3I0 | | |
| R3I3 | | |
| R4I0 | | |

### V. Re-Encoded Instructions

In an embodiment, new instructions are added to the re-encoded legacy instructions as part of an ISA according to an embodiment. These new instructions are designed to reduce code size. Tables 2-5 illustrate formats for the re-encoded instructions for an ISA according to an embodiment. Tables 2 and 3 provide instruction formats for instruction 32-bit instructions of a legacy ISA re-encoded as 16-bit instructions in an ISA according to an embodiment. In an embodiment, selection of which legacy 32-bit ISA instructions to re-encode as 16-bit new ISA instructions is based on a statistical analysis of legacy code to determine more frequently used instructions. An exemplary set of such instructions is provided in Tables 2 and 3. Table 3 provides examples of instruction specific register encoding or immediate field size encoding described above. Table 4 provides instruction formats for 32-bit instructions in the new ISA re-encoded from 32-bit instructions in a legacy ISA according to an embodiment. Table 5 provides instruction formats for 32-bit user defined instructions (UDIs) according to an embodiment.

Tables 2-5 provide in order from the most significant bits formats for an exemplary ISA re-encoding according to an embodiment—defining the register fields, immediate fields, other fields, empty fields, minor opcode field to the major opcode field. As described above, most 32-bit re-encoded instructions have 5-bit wide register fields. In an embodiment, 5-bit wide register fields use linear encoding (r0=‘00000’, r1=‘00001’, etc.). Instructions of 16-bit width can have different size register fields, for example, 3- and 5-bit wide register fields. Register field widths for 16-bit instructions according to an embodiment, are provided in tables 2-5. The ‘other fields’ are defined by the respective column and the order of these fields in the instruction encoding is defined by the order in the tables.

a. New 16-Bit Instructions Re-Encoded from 32-Bit Instructions

As discussed above, in embodiments described herein, a larger bit-width ISA may be re-encoded to a smaller bit-width ISA or a combined smaller and larger bit-width ISA. In one embodiment, to enable the larger ISA to be re-encoded into a smaller ISA, the smaller bit-width ISA instructions have smaller register and immediate fields. In one embodiment, as described above, this reduction may be accomplished by encoding frequently used registers and immediate values.

In one embodiment, an ISA uses both an enhanced 32-bit instruction set and a narrower re-encoded 16-bit instruction set. The re-encoded 16-bit instructions have smaller register and immediate fields, and the reduction in size is accomplished by encoding frequently used registers and immediate values.

For example, listed in table 2 below, re-encodings for frequently used legacy instructions are shown with smaller register and immediate fields corresponding to frequently used registers and immediate values.

TABLE 2
16-Bit Re-encoded Instructions from 32-Bit Instructions

| | Number | | | | | | | |
|---|---|---|---|---|---|---|---|---|
| | of | Immediate | | Total size | Empty 0 | Minor | Major | |
| | Register | Field Size | Register field | of other | Field | Opcode | Opcode | |
| Instruction | Fields | [bit] | width [bit] | fields [bit] | Size [bit] | Size [bit] | Name | Comment |
| ADDIUR1 | 1 | 7 | 3 | | 0 | 0 | ADDIUR116 | Add Immediate |
| | | | | | | | | Unsigned Word |
| | | | | | | | | Same Register |
| ADDIU | 2 | 4 | 3 | | 0 | 0 | ADDIU16 | Add Immediate |
| | | | | | | | | Unsigned Word |
| | | | | | | | | Two Registers |
| ADDU | 3 | 0 | 3 | | 0 | 1 | POOL16A | Add Unsigned |
| | | | | | | | | Word |
| AND | 2 | 0 | 3 | | 0 | 4 | POOL16C | AND |
| ANDI | 2 | 4 | 3 | | 0 | 0 | ANDI16 | AND Immediate |
| B | 0 | 10 | | | 0 | 0 | B16 | Branch |
| BEQZ | 1 | 7 | 3 | | 0 | 0 | BEQZ16 | Branch on Equal |
| | | | | | | | | Zero |
| BNEZ | 1 | 7 | 3 | | 0 | 0 | BNEZ16 | Branch on Not |
| | | | | | | | | Equal Zero |
| BREAK | 0 | 4 | | | 0 | 6 | POOL16C | Cause |
| | | | | | | | | Breakpoint |
| | | | | | | | | Exception |
| JALR | 1 | 0 | 5 | | 0 | 5 | POOL16C | Jump and Link |
| | | | | | | | | Register |
| JR | 1 | 0 | 5 | | 0 | 5 | POOL16C | Jump Register |
| JRC | 1 | 0 | 5 | | 0 | 5 | POOL16C | Jump Register |
| | | | | | | | | Compact |
| LBU | 2 | 4 | 3 | | 0 | 0 | LBU16 | Load Byte |
| | | | | | | | | Unsigned |
| LHU | 2 | 4 | 3 | | 0 | 0 | LHU16 | Load Halfword |
| LI | 1 | 7 | 3 | | 0 | 0 | LI16 | Load Immediate |
| LW | 2 | 4 | 3 | | 0 | 0 | LW16 | Load Word |
| LWSP | 1 | 7 | 3 | | 0 | 0 | LWSP16 | Load Word SP |
| MFHI | 1 | 0 | 5 | | 0 | 5 | POOL16C | Move from HI |
| | | | | | | | | Register |
| MFLO | 1 | 0 | 5 | | 0 | 5 | POOL16C | Move from LO |
| | | | | | | | | Register |
| MOVE | 2 | 0 | 5 | | 0 | 0 | MOVE16 | Move |
| NOT | 2 | 0 | 3 | | 0 | 4 | POOL16C | NOT |
| OR | 2 | 0 | 3 | | 0 | 4 | POOL16C | OR |
| SB | 2 | 4 | 3 | | 0 | 0 | SB16 | Store Byte |
| SDBBP | 0 | 4 | | | 0 | 6 | POOL16C | Cause Debug |
| | | | | | | | | Breakpoint |
| | | | | | | | | Exception |
| SH | 2 | 4 | 3 | | 0 | 0 | SH16 | Store Halfword |
| SLL | 2 | 3 | 3 | | 0 | 1 | POOL16B | Shift Word Left |
| | | | | | | | | Logical |
| SUBU | 3 | 0 | 3 | | 0 | 1 | POOL16A | Sub Unsigned |
| SW | 2 | 4 | 3 | | 0 | 0 | SW16 | Store Word |
| SWSP | 1 | 7 | 3 | | 0 | 0 | SWSP16 | Store Word SP |
| XOR | 2 | 0 | 3 | | 0 | 4 | POOL16C | XOR |

TABLE 3
16-Bit Re-encoded Instructions from 32-Bit Instructions

| | Number of | | | | | |
|---|---|---|---|---|---|---|
| | 3 bit | Immediate | | | | |
| | Register | Field Size | Encoding: | Encoding: | Encoding: | |
| Instruction | Fields | [bit] | Register 1 | Register 2 | Register 3 | Encoding: Immediate Field |
| ADDIUR1 | 1 | 7 | 3-7, 16, 17, | | | (−32 . . . 127) << 2 |
| | | | 29 | | | |
| ADDIU | 2 | 4 | 2-8, 16 | 3-7, 10, 17, | | −40, −32, −24, −1, 1, 2, 4, 8, 16, 24, |
| | | | | 29 | | 32, 40, 48, 56, 64, 72 |
| ADDU | 3 | 0 | 2-9 | 3-10 | 2-9 | |
| AND | 2 | 0 | 2-9 | 2-9 | | |
| ANDI | 2 | 4 | 2-7, 10, 16 | 2-8, 16 | | 1, 2, 3, 4, 7, 8, 15, 16, 31, 32, 63, |
| | | | | | | 64, 128, 255, 32768, 65535 |
| B | 0 | 10 | | | | (−512 . . . 511) << 1 |
| BEQZ | 1 | 7 | 2-8, 16 | | | (−64 . . . 63) << 1 |
| BNEZ | 1 | 7 | 2-8, 16 | | | (−64 . . . 63) << 1 |
| BREAK | 0 | 4 | | | | 0 . . . 15 |
| JALR | 5 bit fields: 1 | 0 | 5 bit field | | | |
| JR | 5 bit fields: 1 | 0 | 5 bit field | | | |
| JRC | 5 bit fields: 1 | 0 | 5 bit field | | | |
| LBU | 2 | 4 | 2-8, 10 | 3-8, 16, 17 | | −1 . . . 14 |
| LHU | 2 | 4 | 2-8, 10 | 3-8, 16, 17 | | (0 . . . 15) << 1 |
| LI | 1 | 7 | 2-9 | | | −1 . . . 126 |
| LW | 2 | 4 | 2-9 | 4-7, 16-19 | | (0 . . . 15) << 2 |
| LWSP | 1 | 7 | 4, 16-21, | | | (0 . . . 127) << 2 |
| | | | 31 | | | |
| MFHI | 5 bit fields: 1 | 0 | 5 bit field | | | |
| MFLO | 5 bit fields: 1 | 0 | 5 bit field | | | |
| MOVE | 5 bit fields: 2 | 0 | 5 bit field | 5 bit field | | |
| NOT | 2 | 0 | 2-9 | 2-9 | | |
| OR | 2 | 0 | 2-9 | 2-9 | | |
| SB | 2 | 4 | 0, 2-8 | 3-8, 16, 17 | | 0 . . . 15 |
| SDBBP | 0 | 4 | | | | 0 . . . 15 |
| SH | 2 | 4 | 0, 2-8 | 3-8, 16, 17 | | (0 . . . 15) << 1 |
| SLL | 2 | 3 | 2-9 | 2-9 | | 1 . . . 8 |
| SUBU | 3 | 0 | 2-9 | 0, 3-9 | 2-9 | |
| SW | 2 | 4 | 0, 2-8 | 4-7, 16-19 | | (0 . . . 15) << 2 |
| SWSP | 1 | 7 | 0, 16-21, | | | (0 . . . 127) << 2 |
| | | | 31 | | | |
| XOR | 2 | 0 | 2-9 | 2-9 | | |

Because the instruction MOVE is a very frequently used instruction, in an embodiment, as described above, the MOVE instruction supports full 5-bit unrestricted register fields so as to reach all available registers, as well as to maximize efficiency.

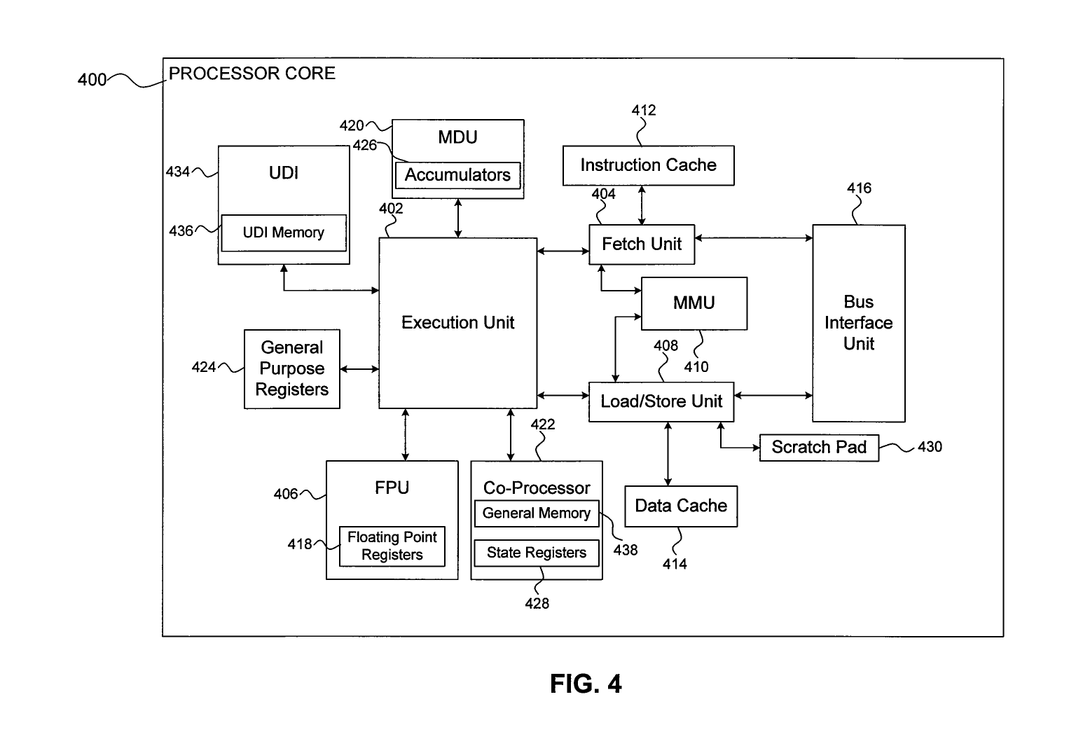

In an embodiment, there are two variants of load word (LW) and store word (SW) instructions. One variant uses the SP register in state registers 428 (see FIG. 4) implicitly to allow for a larger offset field. The value in the offset field is left shifted by 2 before being added to the base address.

In an embodiment, there are two variants of the ADDIU instruction. The first variant of the ADDIU instruction has a larger immediate field and only one register field. In the first variant of the ADDRU instruction, the register field represents a source as well as a destination. The second variant the ADDIU instruction has a smaller immediate field, but two register fields.

16 bit instructions may sometimes result in misalignment. To address this misalignment and to align instructions on a 32-bit boundary in specific cases, a 16-bit NOP instruction is provided in an embodiment described herein. The 16-bit NOP instruction may reduce code size as well.

The NOP instruction is not shown in the table because in the exemplary embodiment, the NOP instruction is implemented as macro. For example, in one embodiment, the 16-bit NOP instruction is implemented as “MOVE16 r0, r0.”

In an embodiment, the compact instruction JRC is preferred over the JR instruction when the jump delay slot after JR cannot be filled. Because the JRC instruction may execute as fast as JR with a NOP in the delay slot, the JR instruction should be used if the delay slot can be filled.

Also, in an embodiment, the breakpoint instructions BREAK and SDBBP include a 16-bit variant. This allows a breakpoint to be inserted at any instruction address without overwriting more than a single instruction.

b. New 32-Bit Instructions Re-Encoded from Legacy 32-Bit Instructions

In an embodiment of the new ISA, legacy 32-bit instructions are re-encoded into new 32-bit instructions. An exemplary such re-encoding is provided in Table 4 below.

TABLE 4
32-Bit Re-encoded Instructions from Legacy 32-Bit Instructions.

| | Number | | | | | | | |
|---|---|---|---|---|---|---|---|---|
| | of | Immediate | | Total size | Empty 0 | Minor | Major | |
| | Register | Field Size | | of other | Field | Opcode | Opcode | |
| Instruction | Fields | [bit] | Other Fields | fields [bit] | Size [bit] | Size [bit] | Name | Comment |
| ABS.fmt | 2 | 0 | fmt: 2 bit | 2 | 0 | 14 | POOL32AXf | |
| ADD | 3 | 0 | | 0 | 0 | 11 | POOL32A | |
| ADD.fmt | 3 | 0 | fmt: 2 bit | 2 | 0 | 9 | POOL32A | |
| ADDI | 2 | 16 | | 0 | 0 | 0 | ADDI32 | |
| ADDIU | 2 | 16 | | 0 | 0 | 0 | ADDIU32 | |
| ADDU | 3 | 0 | | 0 | 0 | 11 | POOL32A | |
| ALNV.PS | 4 | 0 | | 0 | 0 | 6 | POOL32A | |
| AND | 3 | 0 | | 0 | 0 | 11 | POOL32A | |
| ANDI | 2 | 16 | | 0 | 0 | 0 | ANDI32 | |
| BC1F | 0 | 16 | cc: 3 bit | 3 | 0 | 7 | POOL32A | |
| BC1FL | | | | | | | | phased out |
| BC1T | 0 | 16 | cc: 3 bit | 3 | 0 | 7 | POOL32A | |
| BC1TL | | | | | | | | phased out |
| BC2F | 0 | 16 | cc: 3 bit | 3 | 0 | 7 | POOL32A | |
| BC2FL | | | | | | | | phased out |
| BC2T | 0 | 16 | cc: 3 bit | 3 | 0 | 7 | POOL32A | |
| BC2TL | | | | | | | | phased out |
| BEQ/B | 2 | 16 | | 0 | 0 | 0 | B_BEQ32 | |
| BEQL | | | | | | | | phased out |
| BGEZ | 1 | 16 | | 0 | 0 | 5 | POOL32A | |
| BGEZAL | 1 | 16 | | 0 | 0 | 5 | POOL32A | |
| BGEZALL | | | | | | | | phased out |
| BGEZL | | | | | | | | phased out |
| BGTZ | 1 | 16 | | 0 | 0 | 5 | POOL32A | |
| BGTZL | | | | | | | | phased out |
| BLEZ | 1 | 16 | | 0 | 0 | 5 | POOL32A | |
| BLEZL | | | | | | | | phased out |
| BLTZ | 1 | 16 | | 0 | 0 | 5 | POOL32A | |
| BLTZAL | 1 | 16 | | 0 | 0 | 5 | POOL32A | |
| BLTZALL | | | | | | | | phased out |
| BLTZL | | | | | | | | phased out |
| BNE | 2 | 16 | | 0 | 0 | 0 | BNE32 | |
| BNEL | | | | | | | | phased out |
| BREAK | 0 | 0 | code: 6 bit | 6 | 4 | 16 | POOL32AXf | |
| C.cond.fmt | 2 | 0 | fmt: 2 bit/cond: | 8 | 0 | 8 | POOL32A | |
| | | | 4 bit/cc: 2 bit | | | | | |
| CACHE | 1 | 10 | op: 5 bit | 5 | 0 | 6 | POOL32A | limited fields |
| CEIL.L.fmt | 2 | 0 | fmt. 1 bit | 1 | 0 | 15 | POOL32AXf | |
| CEIL.W.fmt | 2 | 0 | fmt: 1 bit | 1 | 0 | 15 | POOL32AXf | |
| CFC1 | 2 | 0 | | 0 | 0 | 16 | POOL32AXf | |
| CFC2 | 1 | 0 | impl: 5 bit | 5 | 0 | 16 | POOL32AXf | |
| CLO | 2 | 0 | | 0 | 0 | 16 | POOL32AXf | |
| CLZ | 2 | 0 | | 0 | 0 | 16 | POOL32AXf | |
| COP2 | 0 | 0 | cofun: 19 | 19 | 0 | 7 | POOL32A | |
| CTC1 | 2 | 0 | | 0 | 0 | 16 | POOL32AXf | |
| CTC2 | 1 | 0 | impl: 5 bit | 5 | 0 | 16 | POOL32AXf | |
| CVT.D.fmt | 2 | 0 | fmt: 2 bit | 2 | 0 | 14 | POOL32AXf | |
| CVT.L.fmt | 2 | 0 | fmt: 1 bit | 1 | 0 | 15 | POOL32AXf | |
| CVT.PS.S | 3 | 0 | | 0 | 0 | 11 | POOL32A | |
| CVT.S.fmt | 2 | 0 | fmt: 2 bit | 2 | 0 | 14 | POOL32AXf | |
| CVT.S.PL | 2 | 0 | | 0 | 0 | 16 | POOL32AXf | |
| CVT.S.PU | 2 | 0 | | 0 | 0 | 16 | POOL32AXf | |
| CVT.W.fmt | 2 | 0 | fmt: 1 bit | 1 | 0 | 15 | POOL32AXf | |
| DERET | 0 | 0 | | 0 | 10 | 16 | POOL32AXf | |
| DI | 1 | 0 | | 0 | 5 | 16 | POOL32AXf | |
| DIV | 2 | 0 | | 0 | 0 | 16 | POOL32AXf | |
| DIV.fmt | 3 | 0 | fmt: 1 bit | 1 | 0 | 10 | POOL32A | |
| DIVU | 2 | 0 | | 0 | 0 | 16 | POOL32AXf | |
| EI | 1 | 0 | | 0 | 5 | 16 | POOL32AXf | |
| EXT | 2 | 10 | | 0 | 0 | 6 | POOL32A | |
| FLOOR.L.fmt | 2 | 0 | fmt: 1 bit | 1 | 0 | 15 | POOL32AXf | |
| FLOOR.W.fmt | 2 | 0 | fmt: 1 bit | 1 | 0 | 15 | POOL32AXf | |
| INS | 2 | 10 | | 0 | 0 | 6 | POOL32A | |
| J | 0 | 26 | | 0 | 0 | 0 | J32 | |
| JAL | 0 | 26 | | 0 | 0 | 0 | JAL32 | |
| JALR/JR | 2 | 0 | | 0 | 0 | 16 | POOL32AXf | |
| JALR.HB | 2 | 0 | | 0 | 0 | 16 | POOL32AXf | |
| JR.HB | 1 | 0 | | 0 | 5 | 16 | POOL32AXf | |
| LB | 2 | 16 | | 0 | 0 | 0 | LB32 | |
| LBU | 2 | 16 | | 0 | 0 | 0 | LBU32 | |
| LDC1 | 2 | 16 | | 0 | 0 | 0 | LDC132 | |
| LDC2 | 2 | 10 | | 0 | 0 | 6 | POOL32A | limited field |
| LDXC1 | 3 | 0 | | 0 | 0 | 11 | POOL32A | |
| LH | 2 | 16 | | 0 | 0 | 0 | LH32 | |
| LHU | 2 | 16 | | 0 | 0 | 0 | LHU32 | |
| LL | 2 | 16 | | 0 | 0 | 0 | LL32 | |
| LUI | 1 | 16 | | 0 | 0 | 5 | POOL32A | |
| LUXC1 | 3 | 0 | | 0 | 0 | 11 | POOL32A | |
| LW | 2 | 16 | | 0 | 0 | 0 | LW32 | |
| LWC1 | 2 | 16 | | 0 | 0 | 0 | LWC132 | |
| LWC2 | 2 | 16 | | 0 | 0 | 0 | LWC232 | |
| LWL | 2 | 16 | | 0 | 0 | 0 | LWL32 | |
| LWR | 2 | 16 | | 0 | 0 | 0 | LWR32 | |
| LWXC1 | 3 | 0 | | 0 | 0 | 11 | POOL32A | |
| MADD | 2 | 0 | | 0 | 0 | 16 | POOL32AXf | |
| MADD.D | 4 | 0 | 3 separate | 0 | 0 | 6 | POOL32A | |
| | | | encodings | | | | | |
| | | | instead of fmt | | | | | |
| | | | field | | | | | |
| MADD.PS | 4 | 0 | 3 separate | 0 | 0 | 6 | POOL32A | |
| | | | encodings | | | | | |
| | | | instead of fmt | | | | | |
| | | | field | | | | | |
| MADD.S | 4 | 0 | 3 separate | 0 | 0 | 6 | POOL32A | |
| | | | encodings | | | | | |
| | | | instead of fmt | | | | | |
| | | | field | | | | | |
| MADDU | 2 | 0 | | 0 | 0 | 16 | POOL32AXf | |
| MFC0 | 2 | 0 | sel: 3 bit | 3 | 0 | 13 | POOL32AXf | |
| MFC1 | 2 | 0 | | 0 | 0 | 16 | POOL32AXf | |
| MFC2 | 1 | 0 | impl: 5 bit | 5 | 0 | 16 | POOL32AXf | |
| MFHC1 | 2 | 0 | | 0 | 0 | 16 | POOL32AXf | |
| MFHC2 | 1 | 0 | impl: 5 bit | 5 | 0 | 16 | POOL32AXf | |
| MFHI | 1 | 0 | | 0 | 5 | 16 | POOL32AXf | |
| MFLO | 1 | 0 | | 0 | 5 | 16 | POOL32AXf | |
| MOV.fmt | 2 | 0 | fmt: 2 bit | 2 | 0 | 14 | POOL32AXf | |
| MOVF | 2 | 0 | | 0 | 0 | 16 | POOL32AXf | |
| MOVF.fmt | 2 | 0 | fmt: 2 bit/cc: | 5 | 0 | 11 | POOL32A | |
| | | | 3 bit | | | | | |
| MOVN | 3 | 0 | | 0 | 0 | 11 | POOL32A | |
| MOVN.fmt | 3 | 0 | fmt: 2 bit | 2 | 0 | 9 | POOL32A | |
| MOVT | 2 | 0 | | 0 | 0 | 16 | POOL32AXf | |
| MOVT.fmt | 2 | 0 | fmt: 2 bit/cc: | 5 | 0 | 11 | POOL32A | |
| | | | 3 bit | | | | | |
| MOVZ | 3 | 0 | | 0 | 0 | 11 | POOL32A | |
| MOVZ.fmt | 3 | 0 | fmt: 2 bit | 2 | 0 | 9 | POOL32A | |
| MSUB | 2 | 0 | | 0 | 0 | 16 | POOL32AXf | |
| MSUB.D | 4 | 0 | 3 separate | 0 | 0 | 6 | POOL32A | |
| | | | encodings | | | | | |
| | | | instead of fmt | | | | | |
| | | | field | | | | | |
| MSUB.PS | 4 | 0 | 3 separate | 0 | 0 | 6 | POOL32A | |
| | | | encodings | | | | | |
| | | | instead of fmt | | | | | |
| | | | field | | | | | |
| MSUB.S | 4 | 0 | 3 separate | 0 | 0 | 6 | POOL32A | |
| | | | encodings | | | | | |
| | | | instead of fmt | | | | | |
| | | | field | | | | | |
| MSUBU | 2 | 0 | | 0 | 0 | 16 | POOL32AXf | |
| MTC0 | 2 | 0 | sel: 3 bit | 3 | 0 | 13 | POOL32AXf | |
| MTC1 | 2 | 0 | | 0 | 0 | 16 | POOL32AXf | |
| MTC2 | 1 | 0 | impl: 5 bit | 5 | 0 | 16 | POOL32AXf | |
| MTHC1 | 2 | 0 | | 0 | 0 | 16 | POOL32AXf | |
| MTHC2 | 1 | 0 | impl: 5 bit | 5 | 0 | 16 | POOL32AXf | |
| MTHI | 1 | 0 | | 0 | 5 | 16 | POOL32AXf | |
| MTLO | 1 | 0 | | 0 | 5 | 16 | POOL32AXf | |
| MUL | 3 | 0 | | 0 | 0 | 11 | POOL32A | |
| MUL.fmt | 3 | 0 | fmt: 2 bit | 2 | 0 | 9 | POOL32A | |
| MULT | 2 | 0 | | 0 | 0 | 16 | POOL32AXf | |
| MULTU | 2 | 0 | | 0 | 0 | 16 | POOL32AXf | |
| NEG.fmt | 2 | 0 | fmt: 2 bit | 2 | 0 | 14 | POOL32AXf | |
| NMADD.D | 4 | 0 | 3 separate | 0 | 0 | 6 | POOL32A | |
| | | | encodings | | | | | |
| | | | instead of fmt | | | | | |
| | | | field | | | | | |
| NMADD.PS | 4 | 0 | 3 separate | 0 | 0 | 6 | POOL32A | |
| | | | encodings | | | | | |
| | | | instead of fmt | | | | | |
| | | | field | | | | | |
| NMADD.S | 4 | 0 | 3 separate | 0 | 0 | 6 | POOL32A | |
| | | | encodings | | | | | |
| | | | instead of fmt | | | | | |
| | | | field | | | | | |
| NMSUB.D | 4 | 0 | 3 separate | 0 | 0 | 6 | POOL32A | |
| | | | encodings | | | | | |
| | | | instead of fmt | | | | | |
| | | | field | | | | | |
| NMSUB.PS | 4 | 0 | 3 separate | 0 | 0 | 6 | POOL32A | |
| | | | encodings | | | | | |
| | | | instead of fmt | | | | | |
| | | | field | | | | | |
| NMSUB.S | 4 | 0 | 3 separate | 0 | 0 | 6 | POOL32A | |
| | | | encodings | | | | | |
| | | | instead of fmt | | | | | |
| | | | field | | | | | |
| NOR | 3 | 0 | | 0 | 0 | 11 | POOL32A | |
| OR | 3 | 0 | | 0 | 0 | 11 | POOL32A | |
| ORI | 2 | 16 | | 0 | 0 | 0 | ORI32 | |
| PLL.PS | 3 | 0 | | 0 | 0 | 11 | POOL32A | |
| PLU.PS | 3 | 0 | | 0 | 0 | 11 | POOL32A | |
| PREF | 1 | 10 | hint: 3 bit | 3 | 0 | 8 | POOL32A | limited field |
| PREFX | 2 | 0 | hint: 3 bit | 3 | 0 | 13 | POOL32AXf | |
| PUL.PS | 3 | 0 | | 0 | 0 | 11 | POOL32A | |
| PUU.PS | 3 | 0 | | 0 | 0 | 11 | POOL32A | |
| RDHWR | 2 | 0 | | 0 | 0 | 16 | POOL32AXf | |
| RDPGPR | 2 | 0 | | 0 | 0 | 16 | POOL32AXf | |
| RECIP.fmt | 2 | 0 | fmt: 1 bit | 1 | 0 | 15 | POOL32AXf | |
| ROTR | 2 | 5 | | 0 | 0 | 11 | POOL32A | |
| ROTRV | 3 | 0 | | 0 | 0 | 11 | POOL32A | |
| ROUND.L.fmt | 2 | 0 | fmt: 1 bit | 1 | 0 | 15 | POOL32AXf | |
| ROUND.W.fmt | 2 | 0 | fmt: 1 bit | 1 | 0 | 15 | POOL32AXf | |
| RSQRT.fmt | 2 | 0 | fmt: 1 bit | 1 | 0 | 15 | POOL32AXf | |
| SB | 2 | 16 | | 0 | 0 | 0 | SB32 | |
| SC | 2 | 16 | | 0 | 0 | 0 | SC32 | |
| SDBBP | 0 | 0 | code: 8 bit | 8 | 2 | 16 | POOL32AXf | |
| SDC1 | 2 | 16 | | 0 | 0 | 0 | SDC132 | |
| SDC2 | 2 | 10 | | 0 | 0 | 6 | POOL32A | limited field |
| SDXC1 | 3 | 0 | | 0 | 0 | 11 | POOL32A | |
| SEB | 2 | 0 | | 0 | 0 | 16 | POOL32AXf | |
| SEH | 2 | 0 | | 0 | 0 | 16 | POOL32AXf | |
| SH | 2 | 16 | | 0 | 0 | 0 | SH32 | |
| SLL | 2 | 5 | | 0 | 0 | 11 | POOL32A | |
| SLLV | 3 | 0 | | 0 | 0 | 11 | POOL32A | |
| SLT | 3 | 0 | | 0 | 0 | 11 | POOL32A | |
| SLTI | 2 | 16 | | 0 | 0 | 0 | SLTI32 | |
| SLTIU | 2 | 16 | | 0 | 0 | 0 | SLTIU32 | |
| SLTU | 3 | 0 | | 0 | 0 | 11 | POOL32A | |
| SQRT.fmt | 2 | 0 | fmt: 1 bit | 1 | 0 | 15 | POOL32AXf | |
| SRA | 2 | 5 | | 0 | 0 | 11 | POOL32A | |
| SRAV | 3 | 0 | | 0 | 0 | 11 | POOL32A | |
| SRL | 2 | 5 | | 0 | 0 | 11 | POOL32A | |
| SRLV | 3 | 0 | | 0 | 0 | 11 | POOL32A | |
| SUB | 3 | 0 | | 0 | 0 | 11 | POOL32A | |
| SUB.fmt | 3 | 0 | fmt: 2 bit | 2 | 0 | 9 | POOL32A | |
| SUBU | 3 | 0 | | 0 | 0 | 11 | POOL32A | |
| SUXC1 | 3 | 0 | | 0 | 0 | 11 | POOL32A | |
| SW | 2 | 16 | | 0 | 0 | 0 | SW32 | |
| SWC1 | 2 | 16 | | 0 | 0 | 0 | SWC132 | |
| SWC2 | 2 | 16 | | 0 | 0 | 0 | SWC232 | |
| SWL | 2 | 16 | | 0 | 0 | 0 | SWL32 | |
| SWR | 2 | 16 | | 0 | 0 | 0 | SWR32 | |
| SWXC1 | 3 | 0 | | 0 | 0 | 11 | POOL32A | |
| SYNC | 0 | 0 | stype: 3 bit | 4 | 6 | 16 | POOL32AXf | |
| SYNCI | 1 | 10 | | 0 | 0 | 11 | POOL32A | limited field |
| SYSCALL | 0 | 0 | code: 8 bit | 8 | 2 | 16 | POOL32AXf | |
| TEQ | 2 | 0 | code: 4 bit | 4 | 0 | 12 | POOL32AXf | |
| TEQI | 1 | 16 | | 0 | 0 | 5 | POOL32A | |
| TGE | 2 | 0 | code: 4 bit | 4 | 0 | 12 | POOL32AXf | |
| TGEI | 1 | 16 | | 0 | 0 | 5 | POOL32A | |
| TGEIU | 1 | 16 | | 0 | 0 | 5 | POOL32A | |
| TGEU | 2 | 0 | code: 4 bit | 4 | 0 | 12 | POOL32AXf | |
| TLBP | 0 | 0 | | 0 | 10 | 16 | POOL32AXf | |
| TLBR | 0 | 0 | | 0 | 10 | 16 | POOL32AXf | |
| TLBWI | 0 | 0 | | 0 | 10 | 16 | POOL32AXf | |
| TLBWR | 0 | 0 | | 0 | 10 | 16 | POOL32AXf | |
| TLT | 2 | 0 | code: 4 bit | 4 | 0 | 12 | POOL32AXf | |
| TLTI | 1 | 16 | | 0 | 0 | 5 | POOL32A | |
| TLTIU | 1 | 16 | | 0 | 0 | 5 | POOL32A | |
| TLTU | 2 | 0 | code: 4 bit | 4 | 0 | 12 | POOL32AXf | |
| TNE | 2 | 0 | code: 4 bit | 4 | 0 | 12 | POOL32AXf | |
| TNEI | 1 | 16 | | 0 | 0 | 5 | POOL32A | |
| TRUNC.L.fmt | 2 | 0 | fmt: 1 bit | 1 | 0 | 15 | POOL32AXf | |
| TRUNC.W.fmt | 2 | 0 | fmt: 1 bit | 1 | 0 | 15 | POOL32AXf | |
| WAIT | 0 | 0 | impl: 8 bit | 8 | 2 | 16 | POOL32AXf | |
| WRPGPR | 2 | 0 | | 0 | 0 | 16 | POOL32AXf | |
| WSBH | 2 | 0 | | 0 | 0 | 16 | POOL32AXf | |
| XOR | 3 | 0 | | 0 | 0 | 11 | POOL32A | |
| XORI | 2 | 16 | | 0 | 0 | 0 | XORI32 | |

c. 16-Bit User Defined Instructions (UDIs)

In an embodiment, the smaller bit-width re-encoded ISA allows user-defined instructions (UDIs). UDIs allow designers to add their own instructions. Table 5 provides an exemplary format for the UDIs. In one embodiment, there are 16 UDI instructions available for designer use.

TABLE 5
UDI Space - 32-Bit

| | Number | | | | | | | |
|---|---|---|---|---|---|---|---|---|
| | of | Immediate | | Total size | Empty 0 | Minor | Major | |
| | Register | Field Size | | of other | Field | Opcode | Opcode | |
| Instruction | Fields | [bit] | Other Fields | fields [bit] | Size [bit] | Size [bit] | Name | Comment |
| UDI | 2 | 0 | user: 10 bit | 10 | 0 | 6 | POOL32B | 16 of these UDI |
| | | | | | | | | instructions |
| | | | | | | | | available |

d. Unification of ASEs

In some cases, ISAs are expanded or provided additional features through extensions such as application specific extensions (ASEs). Because such extensions provide new instructions, they generally require use of at least one additional decoder to process the extension instructions. However, the additional decoders generally require additional chip area. Re-encoding one ISA to another according to embodiments of the present invention allow for integration of instructions of the various extensions when the ISA is recoded. As a result, only a single decoder is required for the integrated new ISA.

For example, in one embodiment Legacy MIPS32 ASE instructions (e.g., MIPS32, MIPS-3D ASE, MIPS DSP ASE, MIPS MT ASE, SmartMIPS ASE, not including MIPS16e) are unified to map to a 16-bit ISA combined with a 32-bit ISA. A benefit of the unified ISA is that it does not require a specialized decoder.

Tables 6-9 provide exemplary re-encoding formats for instructions from 4 exemplary ASEs according to an embodiment.

TABLE 6
32-Bit Re-encoded Instructions from a First 32-Bit ISA ASE

| | | | | | | | | |
|---|---|---|---|---|---|---|---|---|
| | Number | | | | | | | |
| | of | Immediate | | Total size | Empty 0 | Minor | Major | |
| | Register | Field Size | | of other | Field | Opcode | Opcode | |
| Instruction | Fields | [bit] | Other Fields | fields [bit] | Size [bit] | Size [bit] | Name | Comment |

| | | | | | | | |
|---|---|---|---|---|---|---|---|
| ADDR | 3 | 0 | | 0 | 0 | 11 | POOL32A |
| BC1ANY2F | 0 | 16 | cc: 2 bit | 2 | 0 | 8 | POOL32A |
| BC1ANY2T | 0 | 16 | cc: 2 bit | 2 | 0 | 8 | POOL32A |
| BC1ANY4F | 0 | 16 | cc: 2 bit | 2 | 0 | 8 | POOL32A |
| BC1ANY4T | 0 | 16 | cc: 2 bit | 2 | 0 | 8 | POOL32A |
| CABS.cond.fmt | 2 | 0 | fmt: 2 bit/cond: | 8 | 0 | 8 | POOL32A |
| | | | 4 bit/cc: 2 bit | | | | |
| CVT.PS.PW | 2 | 0 | | 0 | 0 | 16 | POOL32AXf |
| CVT.PW.PS | 2 | 0 | | 0 | 0 | 16 | POOL32AXf |
| MULR.PS | 3 | 0 | | 0 | 0 | 11 | POOL32A |
| RECIP1.fmt | 2 | 0 | fmt: 2 bit | 2 | 0 | 14 | POOL32AXf |
| RECIP2.fmt | 3 | 0 | fmt: 2 bit | 2 | 0 | 9 | POOL32A |
| RSQRT1.fmt | 2 | 0 | fmt: 2 bit | 2 | 0 | 14 | POOL32AXf |
| RSQRT2.fmt | 3 | 0 | fmt: 2 bit | 2 | 0 | 9 | POOL32A |

TABLE 7
32-Bit Re-encoded Instructions from a Second 32-Bit ISA ASE

| | Number | | | | | | | |
|---|---|---|---|---|---|---|---|---|
| | of | Immediate | | Total size | Empty 0 | Minor | Major | |
| | Register | Field Size | | of other | Field | Opcode | Opcode | |
| Instruction | Fields | [bit] | Other Fields | fields [bit] | Size [bit] | Size [bit] | Name | Comment |
| ABSQ_S.PH | 2 | 0 | | 0 | 0 | 16 | POOL32AXf | |
| ABSQ_S.QB | 2 | 0 | | 0 | 0 | 16 | POOL32AXf | |
| ABSQ_S.W | 2 | 0 | | 0 | 0 | 16 | POOL32AXf | |
| ADDQ[_S].PH | 3 | 0 | | 0 | 0 | 11 | POOL32A | |
| ADDQ_S.W | 3 | 0 | | 0 | 0 | 11 | POOL32A | |
| ADDQH[_R].PH | 3 | 0 | | 0 | 0 | 11 | POOL32A | |
| ADDQH[_R].W | 3 | 0 | | 0 | 0 | 11 | POOL32A | |
| ADDSC | 3 | 0 | | 0 | 0 | 11 | POOL32A | |
| ADDU[_S].PH | 3 | 0 | | 0 | 0 | 11 | POOL32A | |
| ADDU[_S].QB | 3 | 0 | | 0 | 0 | 11 | POOL32A | |
| ADDUH[_R].QB | 3 | 0 | | 0 | 0 | 11 | POOL32A | |
| ADDWC | 3 | 0 | | 0 | 0 | 11 | POOL32A | |
| APPEND | 3 | 0 | | 0 | 0 | 11 | POOL32A | |
| BALIGN | 2 | 2 | | 0 | 0 | 14 | POOL32AXf | |
| BITREV | 2 | 0 | | 0 | 0 | 16 | POOL32AXf | |
| BPOSGE32 | 0 | 16 | | 0 | 0 | 10 | POOL32A | |
| CMP.cond.PH | 3 | 0 | | 0 | 0 | 11 | POOL32A | |
| CMPGDU.cond.QB | 3 | 0 | | 0 | 0 | 11 | POOL32A | |
| CMPGU.cond.QB | 3 | 0 | | 0 | 0 | 11 | POOL32A | |
| CMPU.cond.QB | 3 | 0 | | 0 | 0 | 11 | POOL32A | |
| DPA.W.PH | 2 | 2 | | 0 | 0 | 14 | POOL32AXf | |
| DPAQ_SA.L.W | 2 | 2 | | 0 | 0 | 14 | POOL32AXf | |
| DPAQX_S.W.PH | 2 | 2 | | 0 | 0 | 14 | POOL32AXf | |
| DPAQX_SA.W.PH | 2 | 2 | | 0 | 0 | 14 | POOL32AXf | |
| DPAU.H.QBL | 2 | 2 | | 0 | 0 | 14 | POOL32AXf | |
| DPAU.H.QBR | 2 | 2 | | 0 | 0 | 14 | POOL32AXf | |
| DPAX.W.PH | 2 | 2 | | 0 | 0 | 14 | POOL32AXf | |
| DPS.W.PH | 2 | 2 | | 0 | 0 | 14 | POOL32AXf | |
| DPSQ_S.W.PH | 2 | 2 | | 0 | 0 | 14 | POOL32AXf | |
| DPSQ_SA.L.W | 2 | 2 | | 0 | 0 | 14 | POOL32AXf | |
| DPSQX_S.W.PH | 2 | 2 | | 0 | 0 | 14 | POOL32AXf | |
| DPSQX_SA.W.PH | 2 | 2 | | 0 | 0 | 14 | POOL32AXf | |
| DPSU.H.QBL | 2 | 2 | | 0 | 0 | 14 | POOL32AXf | |
| DPSU.H.QBR | 2 | 2 | | 0 | 0 | 14 | POOL32AXf | |
| DPSX.W.PH | 2 | 2 | | 0 | 0 | 14 | POOL32AXf | |
| DRAQ_S.W.PH | 2 | 2 | | 0 | 0 | 14 | POOL32AXf | |
| EXTP | 1 | 7 | | 0 | 0 | 14 | POOL32AXf | |
| EXTPDP | 1 | 7 | | 0 | 0 | 14 | POOL32AXf | |
| EXTPDPV | 2 | 2 | | 0 | 0 | 14 | POOL32AXf | |
| EXTPV | 2 | 2 | | 0 | 0 | 14 | POOL32AXf | |
| EXTR[_RS].W | 1 | 7 | | 0 | 0 | 14 | POOL32AXf | |
| EXTR_S.H | 1 | 7 | | 0 | 0 | 14 | POOL32AXf | |
| EXTRV[_RS].W | 2 | 2 | | 0 | 0 | 14 | POOL32AXf | |
| EXTRV_S.H | 2 | 2 | | 0 | 0 | 14 | POOL32AXf | |
| INSV | 2 | 0 | | 0 | 0 | 16 | POOL32AXf | |
| LBUX | 3 | 0 | | 0 | 0 | 11 | POOL32A | |
| LHX | 3 | 0 | | 0 | 0 | 11 | POOL32A | |
| LWX | 3 | 0 | | 0 | 0 | 11 | POOL32A | |
| MADD | 2 | 2 | | 0 | 0 | 14 | POOL32AXf | |
| MADDU | 2 | 2 | | 0 | 0 | 14 | POOL32AXf | |
| MAQ_S[A].W.PHL | 2 | 2 | | 0 | 0 | 14 | POOL32AXf | |
| MAQ_S[A].W.PHR | 2 | 2 | | 0 | 0 | 14 | POOL32AXf | |
| MFHI | 1 | 2 | | 0 | 3 | 16 | POOL32AXf | |
| MFLO | 1 | 2 | | 0 | 3 | 16 | POOL32AXf | |
| MODSUB | 3 | 0 | | 0 | 0 | 11 | POOL32A | |
| MSUB | 2 | 2 | | 0 | 0 | 14 | POOL32AXf | |
| MSUBU | 2 | 2 | | 0 | 0 | 14 | POOL32AXf | |
| MTHI | 1 | 2 | | 0 | 3 | 16 | POOL32AXf | |
| MTHLIP | 1 | 2 | | 0 | 3 | 16 | POOL32AXf | |
| MTLO | 1 | 2 | | 0 | 3 | 16 | POOL32AXf | |
| MUL[_S].PH | 3 | 0 | | 0 | 0 | 11 | POOL32A | |
| MULEQ_S.W.PHL | 3 | 0 | | 0 | 0 | 11 | POOL32A | |
| MULEQ_S.W.PHR | 3 | 0 | | 0 | 0 | 11 | POOL32A | |
| MULEU_S.PH.QBL | 3 | 0 | | 0 | 0 | 11 | POOL32A | |
| MULEU_S.PH.QBR | 3 | 0 | | 0 | 0 | 11 | POOL32A | |
| MULQ_RS.PH | 3 | 0 | | 0 | 0 | 11 | POOL32A | |
| MULQ_RS.W | 3 | 0 | | 0 | 0 | 11 | POOL32A | |
| MULQ_S.PH | 3 | 0 | | 0 | 0 | 11 | POOL32A | |
| MULQ_S.W | 3 | 0 | | 0 | 0 | 11 | POOL32A | |
| MULSA.W.PH | 2 | 2 | | 0 | 0 | 14 | POOL32AXf | |
| MULSAQ_S.W.PH | 2 | 2 | | 0 | 0 | 14 | POOL32AXf | |
| MULT | 2 | 2 | | 0 | 0 | 14 | POOL32AXf | |
| MULTU | 2 | 2 | | 0 | 0 | 14 | POOL32AXf | |
| PACKRL.PH | 3 | 0 | | 0 | 0 | 11 | POOL32A | |
| PICK.PH | 3 | 0 | | 0 | 0 | 11 | POOL32A | |
| PICK.QB | 3 | 0 | | 0 | 0 | 11 | POOL32A | |
| PRECEQ.W.PHL | 2 | 0 | | 0 | 0 | 16 | POOL32AXf | |
| PRECEQ.W.PHR | 2 | 0 | | 0 | 0 | 16 | POOL32AXf | |
| PRECEQU.PH.QBL | 2 | 0 | | 0 | 0 | 16 | POOL32AXf | |
| PRECEQU.PH.QBLA | 2 | 0 | | 0 | 0 | 16 | POOL32AXf | |
| PRECEQU.PH.QBR | 2 | 0 | | 0 | 0 | 16 | POOL32AXf | |
| PRECEQU.PH.QBRA | 2 | 0 | | 0 | 0 | 16 | POOL32AXf | |
| PRECEU.PH.QBL | 2 | 0 | | 0 | 0 | 16 | POOL32AXf | |
| PRECEU.PH.QBLA | 2 | 0 | | 0 | 0 | 16 | POOL32AXf | |
| PRECEU.PH.QBR | 2 | 0 | | 0 | 0 | 16 | POOL32AXf | |
| PRECEU.PH.QBRA | 2 | 0 | | 0 | 0 | 16 | POOL32AXf | |
| PRECR.QB.PH | 3 | 0 | | 0 | 0 | 11 | POOL32A | |
| PRECR_SRA[_R].PH.W | 3 | 0 | | 0 | 0 | 11 | POOL32A | |
| PRECRQ.PH.W | 3 | 0 | | 0 | 0 | 11 | POOL32A | |
| PRECRQ.QB.PH | 3 | 0 | | 0 | 0 | 11 | POOL32A | |
| PRECRQ_RS.PH.W | 3 | 0 | | 0 | 0 | 11 | POOL32A | |
| PRECRQU_S.QB.PH | 3 | 0 | | 0 | 0 | 11 | POOL32A | |
| PREPEND | 3 | 0 | | 0 | 0 | 11 | POOL32A | |
| RADDU.W.QB | 2 | 0 | | 0 | 0 | 16 | POOL32AXf | |
| RDDSP | 1 | 0 | mask: 7 bit | 7 | 0 | 14 | POOL32AXf | |
| REPL.PH | 1 | 10 | | 0 | 0 | 11 | POOL32A | |
| REPL.QB | 1 | 8 | | 0 | 0 | 13 | POOL32AXf | |
| REPLV.PH | 2 | 0 | | 0 | 0 | 16 | POOL32AXf | |
| REPLV.QB | 2 | 0 | | 0 | 0 | 16 | POOL32AXf | |
| SHILO | 0 | 8 | | 0 | 2 | 16 | POOL32AXf | |
| SHILOV | 1 | 2 | | 0 | 3 | 16 | POOL32AXf | |
| SHLL.QB | 2 | 3 | | 0 | 0 | 13 | POOL32AXf | |
| SHLL[_S].PH | 2 | 4 | | 0 | 0 | 12 | POOL32AXf | |
| SHLL_S.W | 2 | 5 | | 0 | 0 | 11 | POOL32A | |
| SHLLV.QB | 3 | 0 | | 0 | 0 | 11 | POOL32A | |
| SHLLV[_S].PH | 3 | 0 | | 0 | 0 | 11 | POOL32A | |
| SHLLV_S.W | 3 | 0 | | 0 | 0 | 11 | POOL32A | |
| SHLV.PH | 3 | 0 | | 0 | 0 | 11 | POOL32A | |
| SHRA[_R].PH | 2 | 4 | | 0 | 0 | 12 | POOL32AXf | |
| SHRA[_R].QB | 2 | 3 | | 0 | 0 | 13 | POOL32AXf | |
| SHRA_R.W | 2 | 5 | | 0 | 0 | 11 | POOL32A | |
| SHRAV[_R].PH | 3 | 0 | | 0 | 0 | 11 | POOL32A | |
| SHRAV[_R].QB | 3 | 0 | | 0 | 0 | 11 | POOL32A | |
| SHRAV_R.W | 3 | 0 | | 0 | 0 | 11 | POOL32A | |
| SHRL.PH | 2 | 4 | | 0 | 0 | 12 | POOL32AXf | |
| SHRL.QB | 2 | 3 | | 0 | 0 | 13 | POOL32AXf | |
| SHRLV.QB | 3 | 0 | | 0 | 0 | 11 | POOL32A | |
| SUBQ[_S].PH | 3 | 0 | | 0 | 0 | 11 | POOL32A | |
| SUBQ_S.W | 3 | 0 | | 0 | 0 | 11 | POOL32A | |
| SUBQH[_R].PH | 3 | 0 | | 0 | 0 | 11 | POOL32A | |
| SUBQH[_R].W | 3 | 0 | | 0 | 0 | 11 | POOL32A | |
| SUBU[_S].PH | 3 | 0 | | 0 | 0 | 11 | POOL32A | |
| SUBU[_S].QB | 3 | 0 | | 0 | 0 | 11 | POOL32A | |
| SUBUH[_R].QB | 3 | 0 | | 0 | 0 | 11 | POOL32A | |
| WRDSP | 1 | 0 | mask: 7 bit | 7 | 0 | 14 | POOL32AXf | |

TABLE 8
32-Bit Re-encoded Instructions from a Third 32-Bit ISA ASE

| | | | | | | | | |
|---|---|---|---|---|---|---|---|---|
| | Number | | | | | | | |
| | of | Immediate | | Total size | Empty 0 | Minor | Major | |
| | Register | Field Size | | of other | Field | Opcode | Opcode | |
| Instruction | Fields | [bit] | Other Fields | fields [bit] | Size [bit] | Size [bit] | Name | Comment |

| | | | | | | | |
|---|---|---|---|---|---|---|---|
| DMT | 1 | 0 | | 0 | 5 | 16 | POOL32AXf |
| DVPE | 1 | 0 | | 0 | 5 | 16 | POOL32AXf |
| EMT | 1 | 0 | | 0 | 5 | 16 | POOL32AXf |
| EVPE | 1 | 0 | | 0 | 5 | 16 | POOL32AXf |
| FORK | 3 | 0 | | 0 | 0 | 11 | POOL32A |
| MFTR | 2 | 5 | rx: 5 bit | 5 | 0 | 6 | POOL32A |
| MTTR | 2 | 5 | rx: 5 bit | 5 | 0 | 6 | POOL32A |
| YIELD | 2 | 0 | | 0 | 0 | 16 | POOL32AXf |

TABLE 9
32-Bit Re-encoded Instructions from a Fourth 32-Bit ISA ASE

| | | | | | | | | |
|---|---|---|---|---|---|---|---|---|
| | Number | | | | | | | |
| | of | Immediate | | Total size | Empty 0 | Minor | Major | |
| | Register | Field Size | | of other | Field | Opcode | Opcode | |
| Instruction | Fields | [bit] | Other Fields | fields [bit] | Size [bit] | Size [bit] | Name | Comment |

| | | | | | | |
|---|---|---|---|---|---|---|
| LWXS | 3 | 0 | 0 | 0 | 11 | POOL32A |
| MADDP | 2 | 0 | 0 | 0 | 16 | POOL32AXf |
| MFLHXU | 1 | 0 | 0 | 5 | 16 | POOL32AXf |
| MTLHX | 1 | 0 | 0 | 5 | 16 | POOL32AXf |
| MULTP | 2 | 0 | 0 | 0 | 16 | POOL32AXf |
| PPERM | 2 | 0 | 0 | 0 | 16 | POOL32AXf |

e. New ISA Instructions

As described above, several new instructions are provided in the new ISA according to an embodiment. The new instructions and their formats for one embodiment are summarized in Table 10.

TABLE 10
New Instructions - 32-Bit

| | Number | | | | | | | |
|---|---|---|---|---|---|---|---|---|
| | of | Immediate | | Total size | Empty 0 | Minor | Major | |
| | Register | Field Size | | of other | Field | Opcode | Opcode | |
| Instruction | Fields | [bit] | Other Fields | fields [bit] | Size [bit] | Size [bit] | Name | Comment |
| BEQZC | 1 | 16 | | 0 | 0 | 5 | POOL32B | Branch Equal |
| | | | | | | | | Zero Compact |
| BNEZC | 1 | 16 | | 0 | 0 | 5 | POOL32B | Branch Not |
| | | | | | | | | Equal Zero |
| | | | | | | | | Compact |
| JALX | 0 | 26 | 0 | 0 | 0 | 0 | JALX | JAL and ISA |
| | | | | | | | | mode switch |
| LRP | 2 | 12 | | 0 | 0 | 4 | POOL32B | Load Register |
| | | | | | | | | Pair |
| LWM | 1 | 0 | reg: 18 | 18 | 0 | 3 | POOL32B | Load Word |
| | | | | | | | | Multiple |
| SRP | 2 | 12 | | 0 | 0 | 4 | POOL32B | Store Register |
| | | | | | | | | Pair |
| SWM | 1 | 0 | reg: 18 | 18 | 0 | 3 | POOL32B | Store Word |
| | | | | | | | | Multiple |

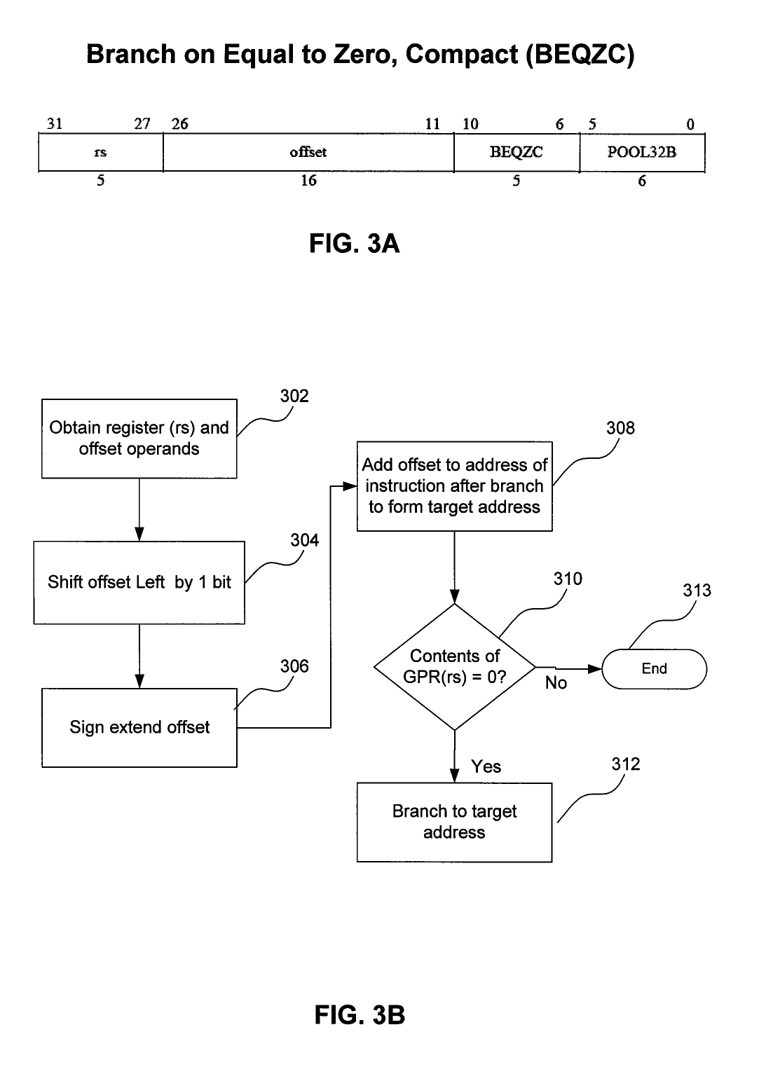

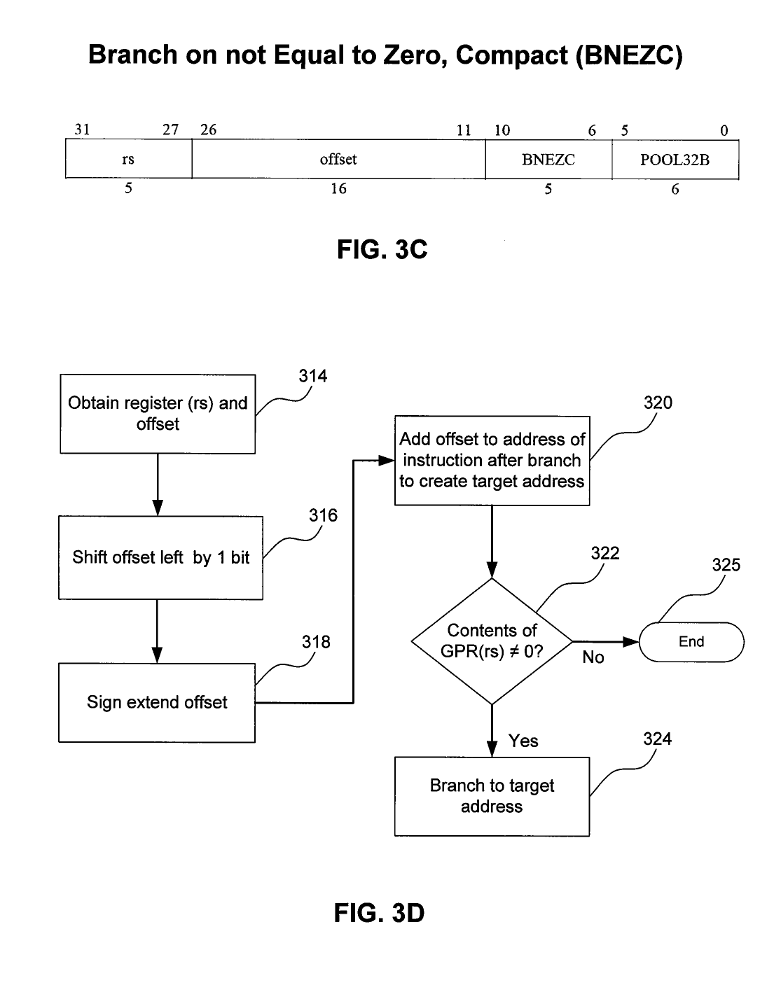

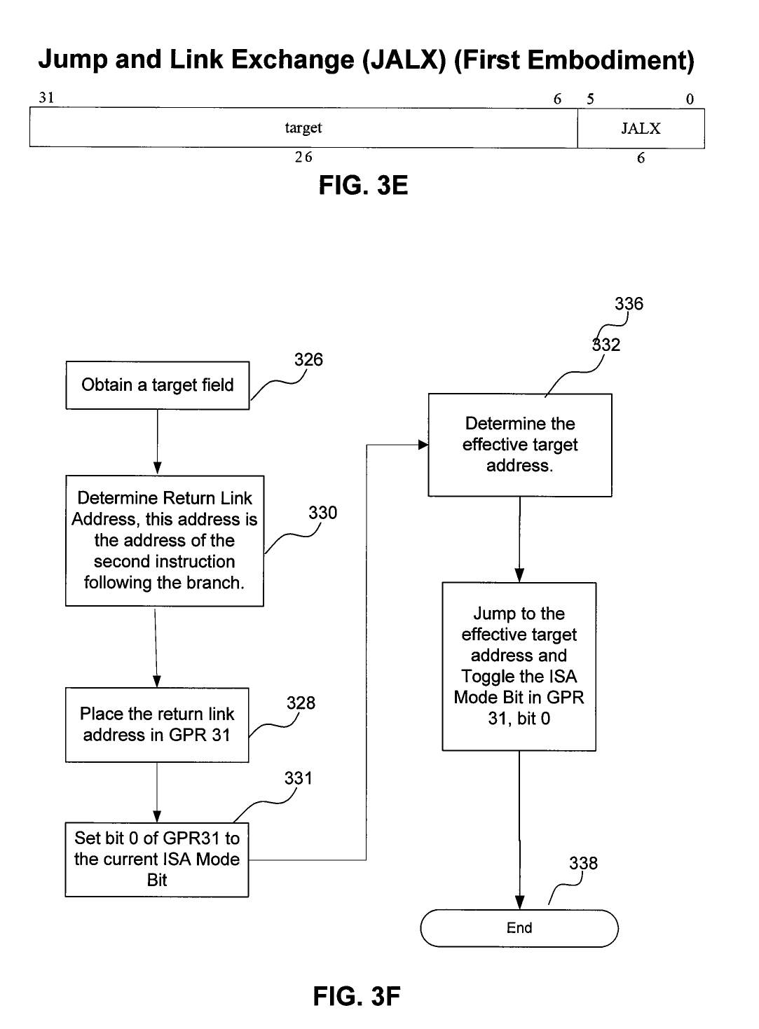

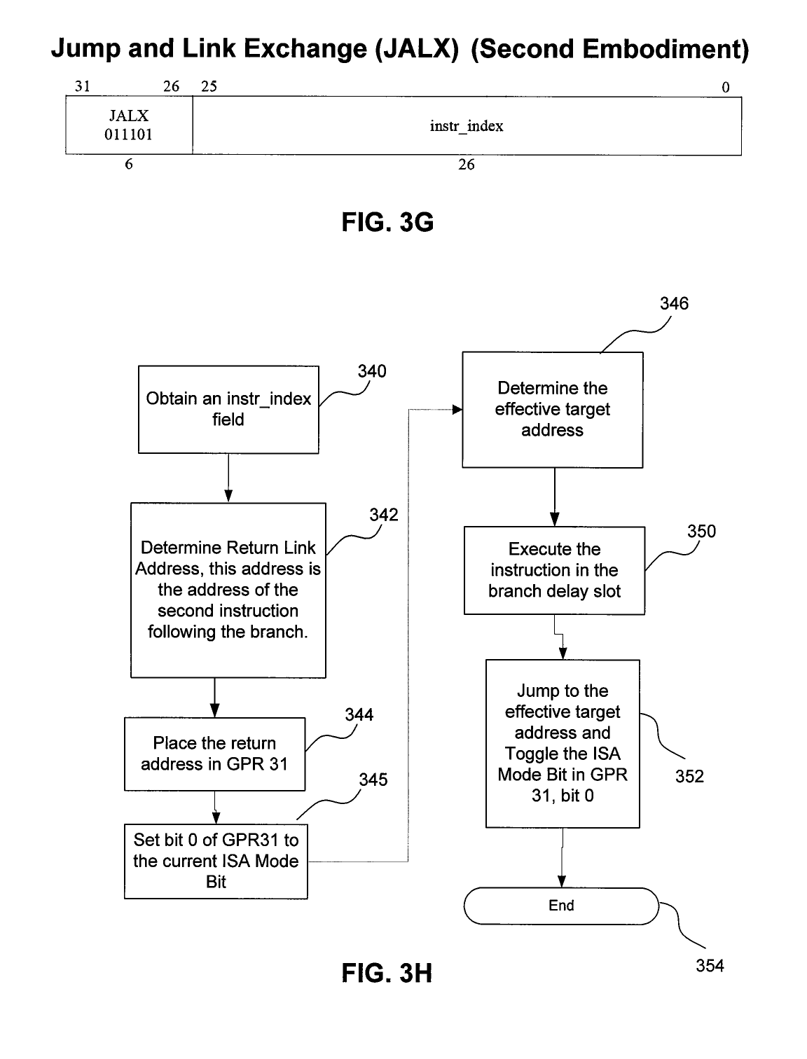

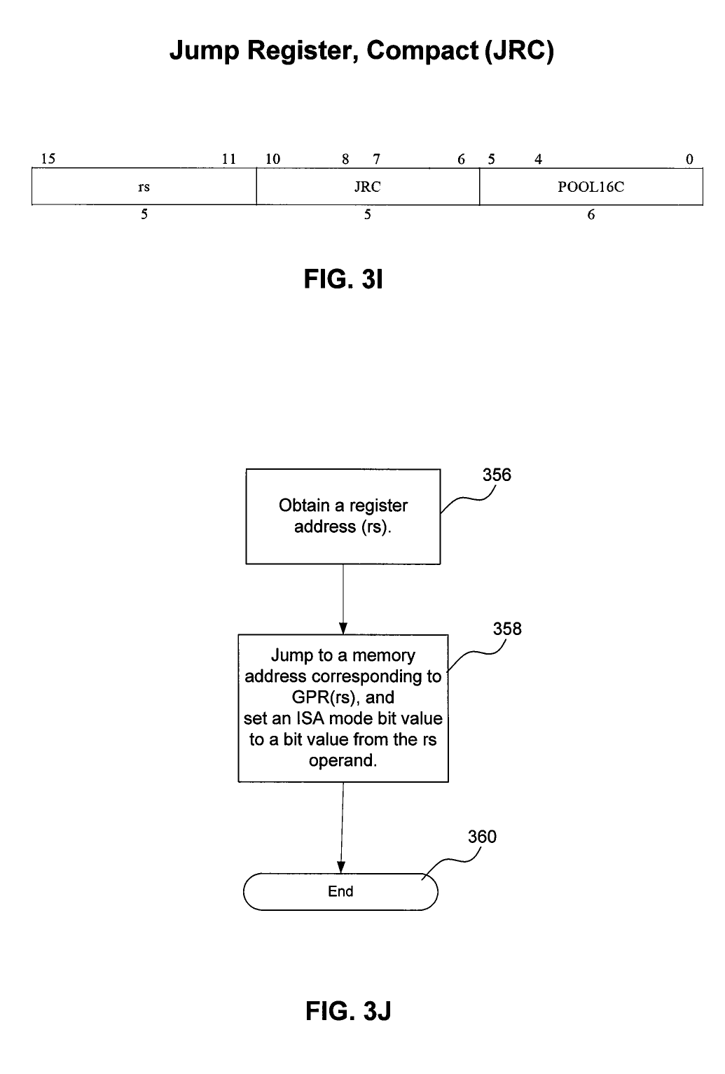

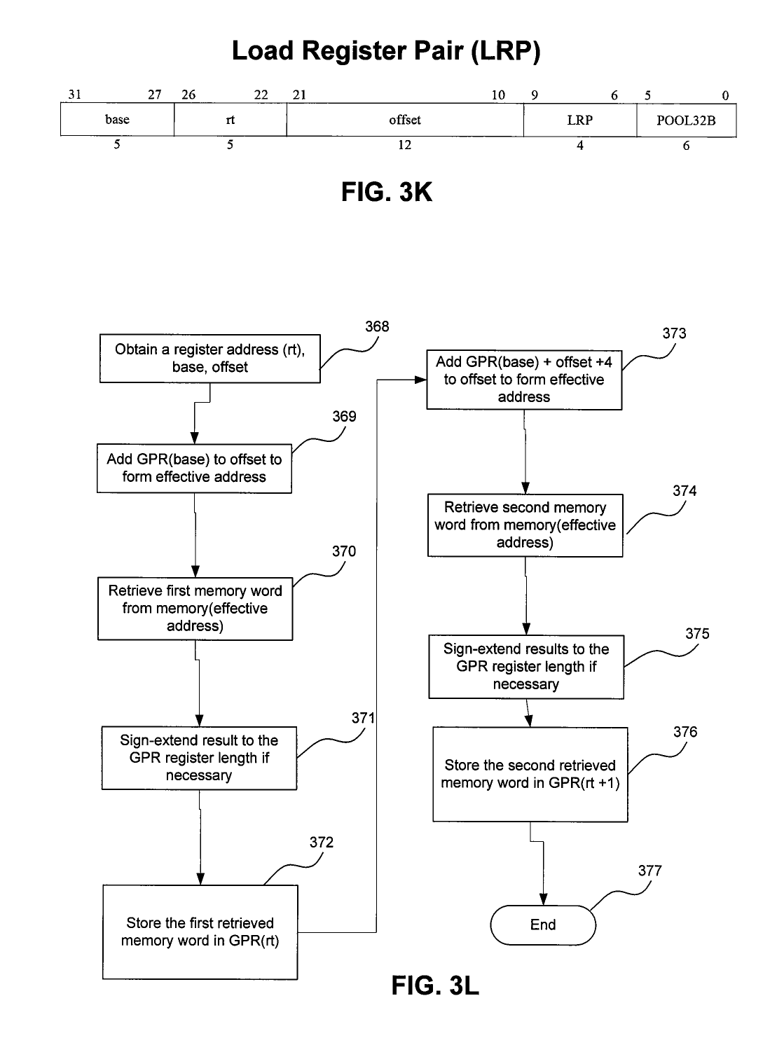

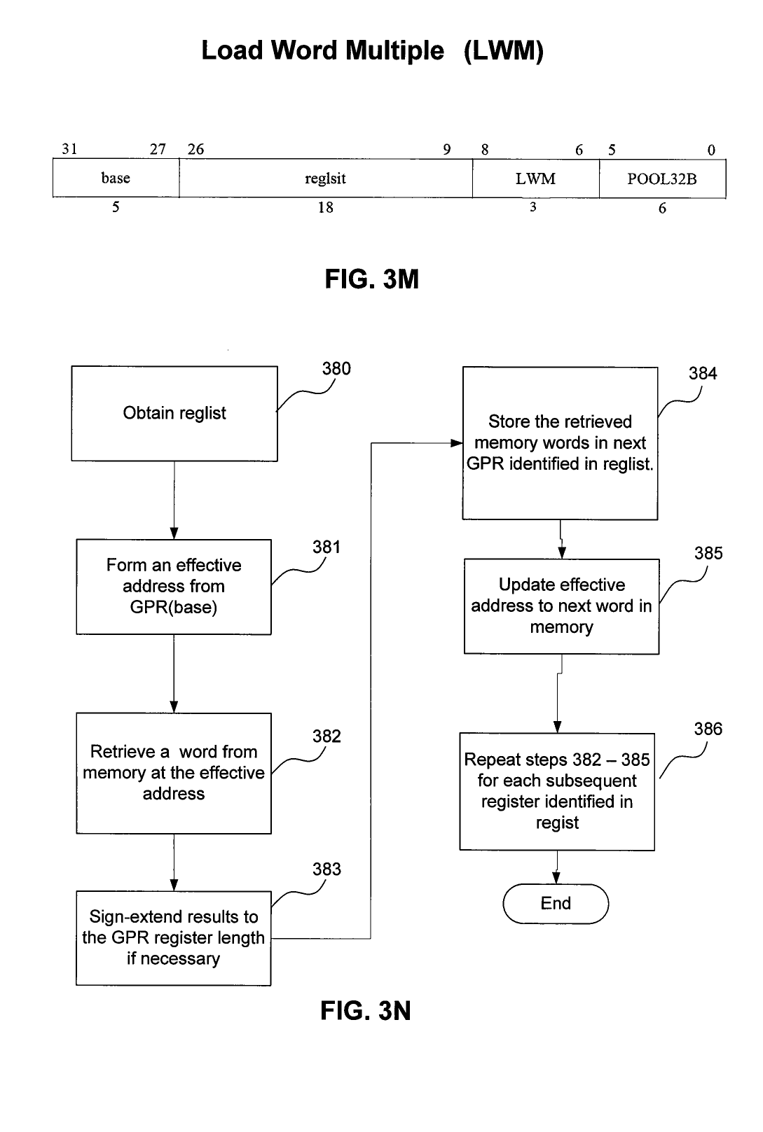

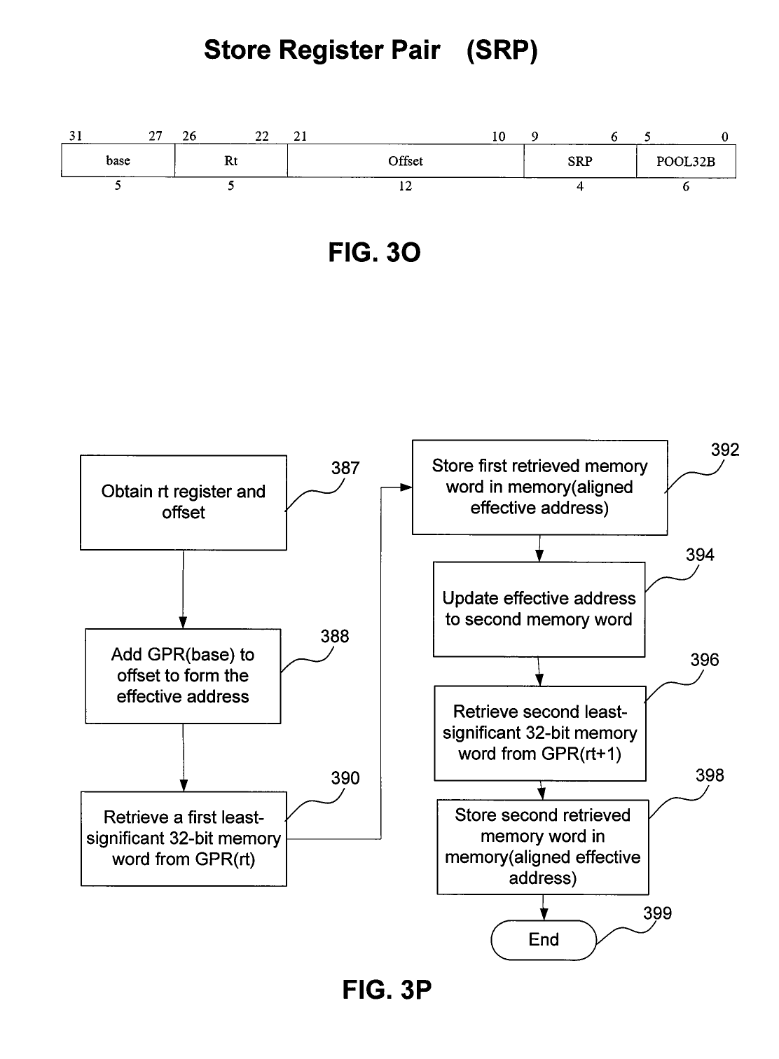

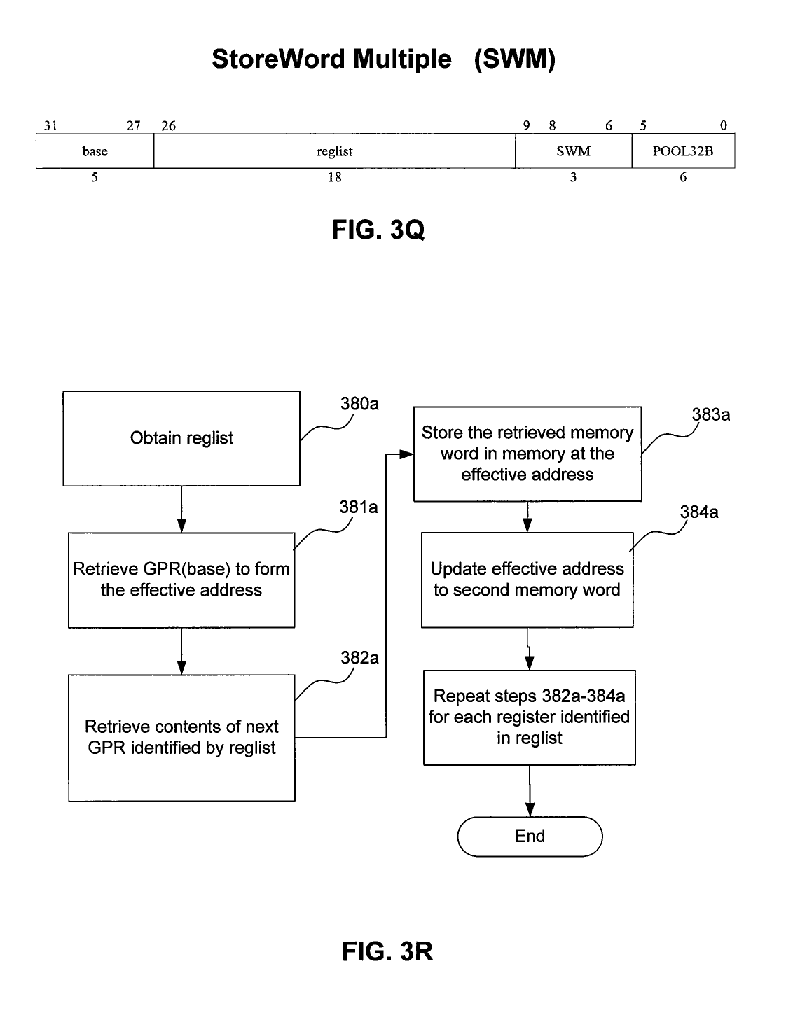

FIGS. 3A-R are flowcharts describing the formats and operation of the instructions summarized in Table 10. The following sections provide the format, purpose, description, restrictions, operation, exceptions, and programming notes for an exemplary embodiment of each instruction.

FIG. 3A is a schematic diagram illustrating the format for a Compact Branch on Equal to Zero (BEQZC) instruction according to an embodiment of the present invention. For coding, the format of the BEQZC instruction is “BEQZC rs, offset,” where rs is a general purpose register and offset is an immediate value offset. The purpose of the BEQZC instruction is to test a GPR. If the value of the GPR is zero (0), the processor performs a PC-relative conditional branch. That is, if (GPR[rs]=0) then branch to the effective target address.

FIG. 3B is a flowchart illustrating operation of a BEQZC instruction in a microprocessor according to an embodiment. In step 302, a register (rs) and offset are obtained. In step 304, the offset is shifted left by one bit. In step 306, the offset is sign extended, if necessary. In step 308, the offset is added to the address of the instruction after the branch to form the target address. In step 310, if the contents of GPR rs equal zero then, in step 312, the program branches to a the target address with no delay slot instruction, otherwise the instruction processing ends in step 313.

Pseudocode describing the above operation is provided as follows:

| | |
|---|---|
| I: | tgt_offset ← sign_extend(offset \|\| 0) |
| | condition ← (GPR[rs] = 0^{GPRLEN}) |
| | if condition then |
| | PC ← (PC + 4) + tgt_offset |
| | endif |

In an embodiment, processor operation is unpredictable if the BEQZC instruction is placed in a delay slot of a branch or jump. In an embodiment, the BEQZC instruction has no restrictions or exceptions. In an embodiment, BEQZC does not have a delay slot.

FIG. 3C is a schematic diagram showing a Compact Branch on Not Equal to Zero (BNEZC) instruction according to an embodiment of the present invention. For coding, the format of the BEQZC instruction is “BNEZC rs, offset,” where rs is a general purpose register and offset is an immediate value offset. The purpose of the BNEZC instruction is to test a GPR. If the value of the GPR is zero (0), the processor performs a PC-relative conditional branch. That is, if (GPR[rs]≠0) then branch.

FIG. 3D is a flowchart illustrating the operation of a BNEZC instruction in a microprocessor according to an embodiment. In step 314, a register (rs) and offset are obtained. In step 316, the offset is then shifted left by one bit and in step 318, the offset operand is sign extended, if necessary. In step 320, the offset is added to the address of the instruction after the branch to form the target address. In step 322, if the contents of GPR rs is not equal to zero then, in step 324, the program branches to the target address with no delay slot instruction, otherwise the instruction processing ends in step 325.

Pseudocode describing the above operation is provided as follows:

| | |
|---|---|
| I: | tgt_offset ← sign_extend(offset \|\| 0) |
| | condition ← (GPR[rs] ≠ 0^{GPRLEN}) |
| | if condition then |
| | PC ← (PC + 4) + tgt_offset |
| | endif |

In an embodiment, processor operation is unpredictable if the BNEZC instruction is placed in a delay slot of a branch or jump. The BNEZC instruction has no restrictions or exceptions. In an embodiment, the BNEZC does not have a delay slot.

FIG. 3E is a schematic diagram showing the format for a Jump and Link Exchange (JALX) instruction according to an embodiment of the present invention. For coding, the format of the JALX instruction is “JALX target” where target is a field to be used in calculating an effective target address for the instruction. The purpose of the JALX instruction is to execute a procedure call and change the ISA Mode, for example from a smaller bit-width instructions set to a larger bit-width instruction set.

FIG. 3F is a flowchart illustrating operation of a JALX instruction in a microprocessor according to an embodiment. In step 326, a target field is obtained. In step 328, a return link address is determined as the address of the next instruction following the branch, where execution continues upon return from the procedure call. In step 330, the return address link is placed in GPR 31. Any GPR can be used for storing the return address link so long as it does not interfere with software execution. The value stored in GPR 31 bit 0 is set to the current value of the ISA Mode bit in step 331. In an embodiment, setting bit 0 of GPR 31 comprises concatenating the value of the ISA Mode bit to the upper 31 bits of the address of the next instruction following the branch.

In an embodiment, the JALX instruction is a PC-region branch, not a PC-relative branch. That is, the effective target address is the “current” 256 MB-aligned region determined as follows. In step 332, the lower 28 bits of the effective target address are obtained by shifting the target field left by 2 bits. In an embodiment, this shift is accomplished by concatenating 2 zeros to the target field value. The remaining upper bits of the effective target address are the corresponding bits of the address of the second instruction following the branch (not of the branch itself). In step 336, jumping to the effective target address is performed along with toggling the ISA Mode bit. The operation ends in step 338.

In an embodiment, the JALX instruction has no restrictions and no exceptions. In an embodiment, the effective target address is formed by adding a signed relative offset to the value of the PC. However, forming the jump target address by concatenating the PC and the shifted 26-bit target field rather than adding a signed offset is advantageous if all program code addresses will fit into a 256 MB region aligned on a 256 MB boundary. Using the concatenated PC and 26-bit target address allows a jump to anywhere in the region from anywhere in the region, which a signed relative offset would not allow.

Pseudocode describing the above operation is provided as follows:

| | |
|---|---|
| I: | GPR[31] ← (PC + 8) _{GPRLEN-1..1} \|\| ISAMode |
| I+1: | PC ← PC_{GPRLEN-1...28} \|\| target \|\| 0² |
| | ISAMode ← (not ISAMode) |

FIG. 3G is a schematic diagram showing the format of a second embodiment of the JALX instruction. JALX 32-bit mode instruction according to an embodiment of the present invention. For coding, the format of the JALX 32-bit instruction is “JALX instr_index” where instr_index is a field to be used in calculating an effective target address for the instruction. The purpose of the JALX 32-bit instruction is to execute a procedure call and change the ISA Mode, for example from a larger bit-width instruction set to a smaller bit-width instruction set.

FIG. 3H is a flowchart illustrating operation of the JALX instruction according to a second embodiment. In step 340, an instr_index field is obtained. In step 342, a return link address is determined as the address of the next instruction following the branch, where execution continues upon return from the procedure call. In step 344, the return address link in is placed in GPR 31. Any GPR can be used for storing the return address link so long as it does not interfere with software execution. The value stored in GPR 31 bit 0 is set to the current value of the ISA Mode bit in step 345. In an embodiment, setting bit 0 of GPR 31 comprises concatenating the value of the ISA Mode bit to the upper 31 bits of the address of the next instruction following the branch.

In an embodiment, the JALX instruction is a PC-region branch, not a PC-relative branch. That is, the effective target address is the “current” 256 MB-aligned region determined as follows. In step 346, the effective target address is determined by shifting the instr_index field left by 2 bits. In an embodiment, this shift is accomplished by concatenating 2 zeros to the target field value. The remaining upper bits of the effective target address are the corresponding bits of the address of the second instruction following the branch (not of the branch itself). In step 350, the instruction in the delay slot is executed. In step 352, jumping to the effective target address is performed along with toggling the ISA Mode bit. The operation ends in step 354.

In an embodiment, the second embodiment of the JALX instruction has no restrictions and no exceptions. In an embodiment, the effective target address is formed by adding a signed relative offset to the value of the PC. However, forming the jump target address by concatenating the PC and the shifted 26-bit target field rather than adding a signed offset is advantageous if all program code addresses will fit into a 256 MB region aligned on a 256 MB boundary. Using the concatenated PC and 26-bit target address allows a jump to anywhere in the region from anywhere in the region, which a signed relative offset would not allow.

In an embodiment, the second embodiment of the JALX instruction supports only 32-bit aligned branch target addresses. In an embodiment, processor operation is unpredictable if a branch, jump, ERET, DERET, or WAIT instruction is placed in the delay slot of a branch or jump. In an embodiment, the JALX 32-bit instruction has no exceptions.

Pseudocode describing the above operation is provided as follows:

| | |
|---|---|
| I: | GPR[31] ← (PC + 8) \|\| ISAMode |
| I+1: | PC ← PC_{GPRLEN-1...28} \|\| instr_index \|\| 0² |
| | ISAMode ← (not ISAMode) |

FIG. 3I is a schematic diagram showing the format for a Compact Jump Register (JRC) instruction according to an embodiment of the present invention. For coding, the format of the JRC instruction is JRC rs, where rs is a general purpose register. The purpose of the JRC instruction is to execute a branch to an instruction address in a register. That is, PC←GPR [rs].

FIG. 3J is a flowchart illustrating operation of a JRC instruction in a microprocessor according to an embodiment. In step 356, a register (rs) is obtained. In step 358, the program unconditionally jumps to the address specified in GPR rs, and the ISA Mode bit is set to the value in GPR rs bit 0. In an embodiment, there is no delay slot instruction. The operation ends in step 360.

In an embodiment, bit 0 of the target address is always zero (0). Because of this, no address exceptions occur when bit 0 of the source register is one (1). In an embodiment, the effective target address in GPR rs must be 32-bit aligned. If bit 0 of GPR rs is zero and bit 1 of GPR rs is one, then an Address Error exception occurs when the jump target is subsequently fetched as an instruction. The JRC instruction has no exceptions.

Pseudocode describing the above operation is provided as follows:

| | |
|---|---|
| I: | PC ← GPR [rs]_{GPRLEN-1..1} \|\| 0 |
| | ISAMode ← GPR [rs]₀ |

FIG. 3K is schematic diagram showing the format for a Load Register Pair (LRP) instruction according to an embodiment of the present invention. In an embodiment, the purpose of the LRP instruction is to load two consecutive words from memory. That is, GPR[rt], GPR [rt+1]←memory [GPR[base]+offset]. For coding, the format of the LRP instruction is “LRP rt, offset (base),” where rt is the first register of the target register pair, base is the register holding the base address to which offset is added to determine the effective address in memory from which to obtain data to be loaded, and offset is an immediate value.

FIG. 3L is a flowchart illustrating operation of an LRP instruction according to an embodiment. In step 368, register (rt), register (base) and offset are obtained. In step 369, GPR(base) is added to offset to form the effective address. In step 370, the contents of the memory location specified by the 32-bit aligned effective address is loaded. In step 371, the loaded word is sign-extended to the GPR register width if necessary. In step 372, the first retrieved word stored in GPR rt. In step 373, the effective address of the second word to be stored is determined by adding GPR(base) to offset+4. In step 374, the contents of the memory location specified by the newly determined effective address are retrieved as the second loaded word. In step 375, the second loaded word is sign-extended to the GPR register width is necessary. In 376, the second memory word is stored in GPR(rt+1). The operation ends in step 377.

In an embodiment, the effective address must be 32-bit aligned. If either of the 2 least-significant bits of the address is non-zero, an Address Error exception occurs. In an embodiment, the behavior of the instructions is architecturally undefined if rt equals GPR 31. The behavior of the LRP instruction is also architecturally undefined, if base and rt are the same. This allows the LRP operation to be restarted if an interrupt or exception aborts the operation in the middle of execution. In an embodiment, the behavior of this instruction is also architecturally undefined, if it is placed in a delay slot of a jump or branch. In an embodiment, the LRP exceptions are: TLB Refill, TLB Invalid, Bus Error, Address Error, and Watch.

Pseudocode describing the above operation is provided as follows:

vAddr 4 ← sign_extend(offset) + GPR[base]
if vAddr_{1...0} ≠ 0² then
Signal Exception(AddressError)
endif
(pAddr, CCA) ← AddressTranslation (vAddr, DATA, LOAD)
memword ← LoadMemory (CCA, WORD, pAddr, vAddr,
DATA)
GPR[rt] ← memword
vAddr ← sign_extend(offset) + GPR[base] + 4
(pAddr, CCA) ← AddressTranslation (vAddr, DATA, LOAD)
memword ← LoadMemory (CCA, WORD, pAddr, vAddr,
DATA)
GPR [rt+1] ← memword

In an embodiment, the LRP instruction may execute for a variable number of cycles and may perform a variable number of stores to memory. Further, in an embodiment. a full restart of the sequence of operations will be performed on return from any exception taken during execution.

FIG. 3M is a schematic diagram showing the format for a Load Word Multiple (LWM) instruction according to an embodiment of the present invention. For coding, the format of the LWM instruction is “LWM reglist, (base),” where reglist is a bit field wherein each bit corresponds to a different register. In another embodiment, reglist is an encoded bit field with each encoded value mapping to a subset of the available registers. In such embodiments, the reglist field can be fewer than 18 bits. In yet another embodiment, reglist identifies a register that contains a bit field in which each bit corresponds to a different register. Again, in such an embodiment, reglist can be fewer than 18 bits. The purpose of the LWM instruction is to load a sequence of consecutive words from memory. That is, GPR [reglist[m]] . . . GPR[reglist[n]]←memory[GPR[base]] . . . memory[GPR[base]+4*(n-m)].

FIG. 3N is a flowchart illustrating operation of the LWM instruction in a microprocessor according to an embodiment. In step 380, a register list (reglist) is obtained. In step 381, an effective address is formed using the contents of GPR(base). In step 382, the content of the memory location specified by the 32-bit aligned effective address is fetched. In step 383, the retrieved word is sign-extended to the GPR register width if necessary. In step 384, the result is stored in the GPR corresponding to the next register identified in reglist. In step 385, the effective address is update to the next word to be loaded from memory. In step 386, steps 382 through 385 are repeated for each register value identified in reglist. The operation ends in step 387.

In an embodiment, the effective address must be 32-bit aligned. If either of the 2 least-significant bits of the address is non-zero, an address error exception occurs. The behavior of the LWM instruction is architecturally undefined if base is included in reglist. The behavior of the LWM instruction is also architecturally undefined, if base is included in reglist, this allowing an operation to be restarted if an interrupt or exception has aborted the operation in the middle of execution. The behavior of this instruction is also architecturally undefined, if it is placed in a delay slot of a jump or branch.

Pseudocode describing the above operation is provided as follows:

```
vAddr 4 ← GPR[base]
if vAddr_{1...0} ≠ 0² then
        SignalException(AddressError)
endif
j ← 1
for i←m to n
    if (reglist[i] ≠ 0)
        (pAddr, CCA) ← AddressTranslation (vAddr, DATA, LOAD)
        memword ← LoadMemory (CCA, WORD, pAddr, vAddr,
        DATA)
        GPR[reglist[i]] ← memword
        vAddr ← GPR[base]+4*j++
    endif
endfor
```

In an embodiment, LWM exceptions are TLB Refill, TLB Invalid, Bus Error, Address Error, and Watch. In an embodiment, the LWM instruction executes for a variable number of cycles and performs a variable number of stores to memory. In an embodiment, a full restart of the sequence of operations is performed on return from any exception taken during execution.

FIG. 3O is a schematic diagram showing the format for a Store Register Pair (SRP) instruction according to an embodiment of the present invention. In an embodiment, the purpose of the SRP instruction is to store two consecutive words to memory. That is, memory[GPR[base]+offset]←GPR[rt], GPR[rt+1]. For coding, the format of the SRP instruction is “SRP rt, offset(base),” where rt is the first register of the source register pair, base is the register holding the base address to which offset is added to determine the effective address in memory to which to store data, and offset is an immediate value.

FIG. 3P is a flowchart illustrating operation of an SRP instruction according to an embodiment. In step 387, the register (rt), register (base), and offset are obtained. In step 388, GPR(base) is added to offset to form the effective address. In step 390, a first least-significant 32-bit memory word is obtained from GPR(rt). In step 392, the obtained first memory word is stored in memory at the location specified by the aligned effective address. In step 394, the effective address is updated as GPR(base)+offset+4 to address the next memory location in which to store data. The offset value is sign extended as required. In step 396, a second least-significant 32-bit memory word is obtained from GPR(rt+1). In step 398, the obtained second memory word is stored in memory at the location specified by the updated aligned effective address. The operation ends in step 399.

A restriction in an embodiment is that the effective address must be 32-bit aligned. If either of the 2 least-significant bits of the address are non-zero, an Address Error exception occurs. In an embodiment, the behavior of this instruction is architecturally undefined, if it is placed in a delay slot of a jump or branch.

In an embodiment, the SRP instruction may execute for a variable number of cycles and may perform a variable number of stores to memory. Further, in an embodiment, a full restart of the sequence of operations is performed on return from any exception taken during execution. In an embodiment, exceptions to the SRP instruction are TLB Refill, TLB Invalid, TLB Modified, Address Error, Watch.

Pseudocode describing the above operation is provided as follows:

vAddr 4 ← sign_extend(offset) + GPR[base]
if vAddr_{1...0} ≠ 0² then
SignalException(AddressError)
endif
(pAddr, CCA) ← AddressTranslation (vAddr, DATA, STORE)
dataword ← GPR[rt]
StoreMemory (CCA, WORD, pAddr, vAddr, DATA)
vAddr ← sign_extend(offset) + GPR[base] + 4
(pAddr, CCA) ← AddressTranslation (vAddr, DATA, STORE)
dataword ← GPR [rt+1]
StoreMemory (CCA, WORD, dataword, pAddr, vAddr, DATA)

FIG. 3Q is a schematic diagram showing the format for a storeword multiple (SWM) instruction according to an embodiment of the present invention. For coding, the format of the SWM instruction is “SWM reglist (base),” where reglist is a bit field wherein each bit corresponds to a different register. In another embodiment, reglist is an encoded bit field with each encoded value mapping to a subset of the available registers. In such embodiments, the reglist field can be fewer than 18 bits. In yet another embodiment, reglist identifies a register that contains a bit field in which each bit corresponds to a different register. Again, in such an embodiment, reglist can be fewer than 18 bits. The purpose of the SWM instruction is to store a sequence of consecutive words to memory. That is, memory[GPR[base] . . . memory[GPR[base]+4*[n-m]]←GPR[reglist[m]] . . . [GPR[reglist[n]].

FIG. 3R is a flowchart illustrating operation of a SWM instruction according to an embodiment. In step 380a, a register list (reglist) is obtained. In step 381a, an effective address is formed using the contents of GPR(base). In step 382a, the least-significant 32-bit word of the next GPR identified by reglist is obtained. In step 383a, the obtained data is stored in memory at the address corresponding to the effective address. In step 384a, the effective address is updated to the next address for writing data in memory. In step 385a, steps 382a through 384a are repeated for each register identified in reglist.

In an embodiment, the restrictions on the SWM instruction are that the effective address must be 32-bit aligned. If either of the 2 least-significant bits of the address is non-zero, an address error exception occurs. In an embodiment, the behavior of this instruction is architecturally undefined, if it is placed in a delay slot of a jump or branch. In an embodiment, the LWM instruction executes for a variable number of cycles and performs a variable number of stores to memory. A full restart of the sequence of operations will be performed on return from any exception taken during execution. In an embodiment, exceptions to SWM are TLB Refill, TLB Invalid, TLB Modified, Address Error, Watch.

Pseudocode describing the above operation is provided as follows:

```
vAddr ← GPR[base]
if vAddr_{1..0} ≠ 0² then
    SignalException(AddressError)
endif
j ← 1
for i ←m to n
    if (reglist[i] ≠ 0)
        (pAddr, CCA) ← AddressTranslation (vAddr, DATA, STORE)
        dataword ← GPR[reglist[i]]
        StoreMemory (CCA, WORD, pAddr, vAddr, DATA)
        vAddr ← GPR[base] + 4*j++
    endif
endfor
```

### VI. Example Processor Core

FIG. 4 is a schematic diagram of an exemplary processor core 400 according to an embodiment of the present invention for implementing an ISA according to embodiments of the present invention. Processor core 400 is an exemplary processor intended to be illustrative, and not intended to be limiting. Those skilled in the art would recognize numerous processor implementations for use with an ISA according to embodiments of the present invention.

As shown in FIG. 4, processor core 400 includes an execution unit 402, a fetch unit 404, a floating point unit 406, a load/store unit 408, a memory management unit (MMU) 410, an instruction cache 412, a data cache 414, a bus interface unit 416, a multiply/divide unit (MDU) 420, a co-processor 422, general purpose registers 424, a scratch pad 430, and a core extend unit 434. While processor core 400 is described herein as including several separate components, many of these components are optional components and will not be present in each embodiment of the present invention, or components that may be combined, for example, so that the functionality of two components reside within a single component. Additional components may also be added. Thus, the individual components shown in FIG. 4 are illustrative and not intended to limit the present invention.

Execution unit 402 preferably implements a load-store (RISC) architecture with single-cycle arithmetic logic unit operations (e.g., logical, shift, add, subtract, etc.). Execution unit 402 interfaces with fetch unit 404, floating point unit 406, load/store unit 408, multiple-divide unit 420, co-processor 422, general purpose registers 424, and core extend unit 434.

Fetch unit 404 is responsible for providing instructions to execution unit 402. In one embodiment, fetch unit 404 includes control logic for instruction cache 412, a recoder for recoding compressed format instructions, dynamic branch prediction and an instruction buffer to decouple operation of fetch unit 404 from execution unit 402. Fetch unit 404 interfaces with execution unit 402, memory management unit 410, instruction cache 412, and bus interface unit 416.

Floating point unit 406 interfaces with execution unit 402 and operates on non-integer data. Floating point unit 406 includes floating point registers 418. In one embodiment, floating point registers 418 may be external to floating point unit 406. Floating point registers 418 may be 32-bit or 64-bit registers used for floating point operations performed by floating point unit 406. Typical floating point operations are arithmetic, such as addition and multiplication, and may also include exponential or trigonometric calculations.

Load/store unit 408 is responsible for data loads and stores, and includes data cache control logic. Load/store unit 408 interfaces with data cache 414 and scratch pad 430 and/or a fill buffer (not shown). Load/store unit 408 also interfaces with memory management unit 410 and bus interface unit 416.

Memory management unit 410 translates virtual addresses to physical addresses for memory access. In one embodiment, memory management unit 410 includes a translation lookaside buffer (TLB) and may include a separate instruction TLB and a separate data TLB. Memory management unit 410 interfaces with fetch unit 404 and load/store unit 408.

Instruction cache 412 is an on-chip memory array organized as a multi-way set associative or direct associative cache such as, for example, a 2-way set associative cache, a 4-way set associative cache, an 8-way set associative cache, et cetera. Instruction cache 412 is preferably virtually indexed and physically tagged, thereby allowing virtual-to-physical address translations to occur in parallel with cache accesses. In one embodiment, the tags include a valid bit and optional parity bits in addition to physical address bits. Instruction cache 412 interfaces with fetch unit 404.

Data cache 414 is also an on-chip memory array. Data cache 414 is preferably virtually indexed and physically tagged. In one embodiment, the tags include a valid bit and optional parity bits in addition to physical address bits. Data cache 414 interfaces with load/store unit 408.

Bus interface unit 416 controls external interface signals for processor core 400. In an embodiment, bus interface unit 416 includes a collapsing write buffer used to merge write-through transactions and gather writes from uncached stores.

Multiply/divide unit 420 performs multiply and divide operations for processor core 400. In one embodiment, multiply/divide unit 420 preferably includes a pipelined multiplier, accumulation registers (accumulators) 426, and multiply and divide state machines, as well as all the control logic required to perform, for example, multiply, multiply-add, and divide functions. As shown in FIG. 4, multiply/divide unit 420 interfaces with execution unit 402. Accumulators 426 are used to store results of arithmetic performed by multiply/divide unit 420.

Co-processor 422 performs various overhead functions for processor core 400. In one embodiment, co-processor 422 is responsible for virtual-to-physical address translations, implementing cache protocols, exception handling, operating mode selection, and enabling/disabling interrupt functions. Co-processor 422 interfaces with execution unit 402. Co-processor 422 includes state registers 428 and general memory 438. State registers 428 are generally used to hold variables used by co-processor 422. State registers 428 may also include registers for holding state information generally for processor core 400. For example, state registers 428 may include a status register. General memory 438 may be used to hold temporary values such as coefficients generated during computations. In one embodiment, general memory 438 is in the form of a register file.

General purpose registers 424 are typically 32-bit or 64-bit registers used for scalar integer operations and address calculations. In one embodiment, general purpose registers 424 are a part of execution unit 424. Optionally, one or more additional register file sets, such as shadow register file sets, can be included to minimize content switching overhead, for example, during interrupt and/or exception processing.

Scratch pad 430 is a memory that stores or supplies data to load/store unit 408. The one or more specific address regions of a scratch pad may be pre-configured or configured programmatically while processor 400 is running. An address region is a continuous range of addresses that may be specified, for example, by a base address and a region size. When base address and region size are used, the base address specifies the start of the address region and the region size, for example, is added to the base address to specify the end of the address region. Typically, once an address region is specified for a scratch pad, all data corresponding to the specified address region are retrieved from the scratch pad.

User Defined Instruction (UDI) unit 434 allows processor core 400 to be tailored for specific applications. UDI 434 allows a user to define and add their own instructions that may operate on data stored, for example, in general purpose registers 424. UDI 434 allows users to add new capabilities while maintaining compatibility with industry standard architectures. UDI 434 includes UDI memory 436 that may be used to store user added instructions and variables generated during computation. In one embodiment, UDI memory 436 is in the form of a register file.

### VII. Conclusion

The summary and abstract sections may set forth one or more but not all exemplary embodiments of the present invention as contemplated by the inventors, and thus, are not intended to limit the present invention and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

1-3. (canceled)

4. A RISC processor to execute instructions belonging to an instruction set architecture having at least two different sizes, comprising:
an instruction fetch unit to fetch at least one instruction per cycle;
an instruction decode unit configured to determine a size of each fetched instruction and decode each fetched instruction according to its determined size; and
an execution unit to execute the decoded instructions, wherein the instructions in the instruction set architecture are backward compatible for a compiler used with a legacy processor.

5. The RISC processor of claim 4, wherein the instruction size for a particular instruction in the instruction set architecture is determined based on a statistical analysis of instruction usage.

6. The RISC processor of claim 5, wherein a smaller size instruction is provided for instructions that are more often used.

7. The RISC processor of claim 4, wherein the instruction set architecture comprises instructions having only three sizes.

8. The RISC processor of claim 7, wherein the instruction set architecture comprises:
a first group of instructions having 16 bits;
a second group of instructions having 32 bits; and
a third group of instructions having 48 bits.

9. The RISC processor of claim 4, wherein each instruction in the instruction set architecture has a format comprising:
zero, one, or, more register fields beginning in the most significant bits of the instruction format;
zero, one, or more immediate fields beginning with the last register, if present; and
an opcode filed beginning with the last immediate field, if present.

10. The RISC processor of claim 9, wherein each register field is 5 bits in size.

11. The RISC processor of claim 9, wherein each register field is 3 bits in size.

12. A computer readable storage medium having encoded thereon computer readable program code for generating a RISC processor to execute instructions belonging to an instruction set architecture having at least two different sizes, the computer readable program code comprising:
computer readable program code to generate an instruction fetch unit to fetch at least one instruction per cycle;
computer readable program code to generate an instruction decode unit configured to determine a size of each fetched instruction and decode each fetched instruction according to its determined size; and
computer readable program code to generate an execution unit to execute the decoded instructions, wherein the instructions in the instruction set architecture are backward compatible for a compiler used with a legacy processor.

13. The computer readable storage medium of claim 12, wherein the instruction size for a particular instruction in the instruction set architecture is determined based on a statistical analysis of instruction usage.

14. The computer readable storage medium of claim 13, wherein a smaller size instruction is provided for instructions that are more often used.

15. The computer readable storage medium of claim 12, wherein the instruction set architecture comprises instructions having only three sizes.

16. The computer readable storage medium of claim 15, wherein the instruction set architecture comprises:
a first group of instructions having 16 bits;
a second group of instructions having 32 bits; and
a third group of instructions having 48 bits.

17. The computer readable storage medium of claim 12, wherein each instruction in the instruction set architecture has a format comprising:
zero, one, or, more register fields beginning in the most significant bits of the instruction format;
zero, one, or more immediate fields beginning with the last register, if present; and
an opcode filed beginning with the last immediate field, if present.

18. The computer readable storage medium of claim 17, wherein each register field is 5 bits in size.

19. The computer readable storage medium of claim 17, wherein each register field is 3 bits in size.

20. A method for processing instructions belonging to an instruction set architecture having at least two different sizes, comprising:
fetching at least one instruction per cycle;
determining a size of each fetched instruction;
decoding each fetched instruction according to its determined size; and
executing the decoded instructions, wherein the instructions in the instruction set architecture are backward compatible for a compiler used with a legacy processor.

21. The method of claim 20, further comprising determining the instruction size for a particular instruction in the instruction set architecture based on a statistical analysis of instruction usage.

22. The method of claim 21, further comprising providing a smaller size instruction for instructions that are more often used.

23. The method of claim 20, wherein the instruction set architecture comprises instructions having only three sizes.

24. The method of claim 23, wherein the instruction set architecture comprises:
a first group of instructions having 16 bits;
a second group of instructions having 32 bits; and
a third group of instructions having 48 bits.

25. The method of claim 20, wherein each instruction in the instruction set architecture has a format comprising:
zero, one, or, more register fields beginning in the most significant bits of the instruction format;
zero, one, or more immediate fields beginning with the last register, if present; and
an opcode filed beginning with the last immediate field, if present.

26. The method of claim 25, wherein each register field is 5 bits in size.

27. The method of claim 25, wherein each register field is 3 bits in size.
